(19) United States
(12) Patent Application Publication
(10) Pub. No.: US 2003/0031987 A1
(43) Pub. Date: Feb. 13, 2003

(54) Manipulative visual language tool and method

(76) Inventors: Jimmy Challis Gore, Frederick, MD (US); Robert C. Gillies, Yarmouth, ME (US)

Correspondence Address: Lynne M. Blank, Esq., 2329 Centreview Trail, Macedon, NY, 14502, US

(21) Appl. No.: 10/158,652

(22) Filed: May 30, 2002

Related U.S. Application Data
(60) Provisional application No. 60/294,753, filed on May 31, 2001.

(51) Int. Cl. G09B 19/00

(52) U.S. Cl. 434/156

(57) ABSTRACT

The present invention relates to a manipulative visual language tool for teaching grammar and syntax of a language comprising at least one colored shape further comprising a graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech. In a further embodiment, the present invention discloses a method of using the disclosed manipulative visual language tool.

### CROSS REFERENCE TO RELATED APPLICATIONS

Priority is claimed from co-pending U.S. Provisional Patent Application: Serial No. 60/294,753 by Gore et al. filed May 31, 2001 entitled “Manipulative Visual Language Tool and Method.”

### FIELD OF THE INVENTION

The present invention relates to a manipulative visual language tool and method for improving the literacy skills of students.

### BACKGROUND OF THE INVENTION

For many students, English is a very difficult language to learn. Apart from a huge vocabulary, there is the syntax or code to confront. Young children learn language through constant modeling of the spoken language that surrounds them. Through this constant repetition in the formative years, the syntax of the language is assimilated. The various forms of the verb “to be”, articles, pronouns, prepositions, adjectives, and verb tenses are learned after the child has experienced a large amount of exposure to them. For example, a child understands the correctness of “the dog is eating the fish” long before being able to explain what “the”, “is” and the suffix “-ing” mean in the sentence. The child knows this sounds right, as opposed to “dog eat fish” which sounds wrong.

There are many possible variations within the basic structure of a sentence. For example:

| | | | | |
|---|---|---|---|---|
| The | | eats | | a |
| A | | ate | | my |
| My | dog | is | eating | this |
| fish. | | | | |
| That | | did | eat | her |
| This | | has | eaten | the |
| Some | | was | eating | that |

This is obviously not the complete list of possibilities or variations within that Subject-Verb-Object structure. Every sentence made from the above list alters the meaning of the sentence. The syntax is extremely complicated and takes a lot of time and practice to master.

Most people in general are visual learners and the use of visual blocks as an educational tool is well known. The use of blocks as an educational tool for deaf children is less well known. The prior art has made several limited attempts to provide block assemblies particularly adapted for use by deaf children. U.S. Pat. No. 4,846,687 (White et al.) discloses a set of twenty-six blocks with manual signs. Each block has a predetermined alphabet letter, a pictorial face whose spelling begins with the predetermined alphabet letter, and a removable face with an illustrative manual designation. U.S. Pat. No. 5,152,690 (Todd) discloses a set of thirteen blocks with two letters per block. The letters on each block have visual and tactile presentations for aiding the deaf and vision impaired. U.S. Pat. No. 3,858,333 (Kopp) discloses an educational game apparatus for teaching manual representations of the alphabet which comprises at least one set of at least five cubes, each cube face bearing indicia corresponding to a letter of the manual alphabet or a word using a manual alphabet, and at least one interpreter card bearing an entire manual alphabet.

Basic shapes have been used to represent to represent various parts of speech in some Montessori schools. Black equilateral triangles have represented nouns, red circles have represented verbs, purple triangles have represented pronouns, green crescents have represented prepositions, and blue equilateral triangles have represented adjectives. There is a very nice logic behind the shapes, and students are often introduced to the shapes with stories. The shapes have their own personalities, which explain their origin and purpose. However, these shapes alone, although very useful, are not able to convey enough information to students. Many students, especially deaf students, struggle with pronouns, articles, prepositions, order of adjectives, and, perhaps above all, verbs. For example, we needed to show the different forms of verbs, nouns, adjectives and pronouns. The shapes are not sufficient.

Therefore, it is an object of this invention to provide a visual system for learning the grammar and syntax of a language.

### SUMMARY OF THE INVENTION

The present invention comprises a manipulative visual language tool for teaching grammar and syntax of a language comprising at least one colored shape further comprising a graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech. In a further embodiment, the present invention discloses a method of teaching the grammar and syntax of a language comprising providing a manipulative visual language tool for teaching grammar and syntax of a language comprising at least one colored shape further comprising at least one graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech and exposing at least one individual to said manipulative visual language tool.

The present invention includes several advantages. The present invention provides students with a visual model of a language in its basic forms. The present invention is intended to establish a strong foundation in understanding the grammar and syntax of a language. The present invention presents students of any language with a system of symbols that are based on a clear system of logic that is also visual and tactile. In addition, the present invention can be adapted to teaching many languages, including foreign language structure and syntax to students. Also, this system provides a visual alternative mechanism of learning syntax to audio exposure, which is unworkable in the case of a deaf child.

### BRIEF DESCRIPTION OF THE DRAWINGS

FIG. 1 represents a preferred embodiment of the present invention for nouns.

FIG. 2 represents a preferred embodiment of the present invention for verbs.

FIG. 3 represents a preferred embodiment of the present invention wherein the tool comprises a set of colored shapes for a language as disclosed in the present invention.

FIG. 4 represents a preferred embodiment of the present invention for two-dimensional adjectives.

FIG. 5 represents a preferred embodiment of the present invention for three-dimensional adjectives.

FIG. 6 represents a preferred embodiment of the present invention for two-dimensional pronouns.

FIG. 7 represents a preferred embodiment of the present invention for three-dimensional pronouns.

FIG. 8 represents a preferred embodiment of the present invention for adverbs.

FIG. 9 represents a preferred embodiment of the present invention for prepositions.

FIG. 10 represents a preferred embodiment of the present invention for negatives.

FIG. 11 represents the sentence “The dog was bitten by the wolf” utilizing the present invention.

FIG. 12 represents the sentence “Clayton fixed his bike in the basement.” utilizing the present invention.

FIG. 13 represents the sentence fragment “her new doll” utilizing the present invention.

FIG. 14 represents the sentence fragment “Rob's old car” utilizing the present invention.

FIG. 15 represents the sentence “Clayton walked into the classroom, rubbing his elbow.” utilizing the present invention.

FIG. 16 represents the sentence fragment “between the big black chairs” utilizing the present invention.

FIG. 17 represents the sentence “Seth is happy.” utilizing the present invention.

FIG. 18 represents the sentence “The dog is black.” utilizing the present invention.

FIG. 19 represents the sentence fragment “on the top of the hill” utilizing the present invention.

FIG. 20 represents the sentence “John is running.” utilizing the present invention.

FIG. 21 represents the sentence “The moose walks across the street.” utilizing the present invention.

FIG. 22 represents the sentence “Bob walks to the store.” utilizing the present invention.

FIG. 23 represents the sentence “Paul runs.” utilizing the present invention.

FIG. 24 represents the sentence “The dog walks.” utilizing the present invention.

FIG. 25 represents the sentence fragment “Scott had chased.” utilizing the present invention.

FIG. 26 represents the sentence “The cat ran.” utilizing the present invention.

FIG. 27 represents the sentence “Our cat scratched.” utilizing the present invention.

FIG. 28 represents the sentence “The clerk is a stranger.” utilizing the present invention.

FIG. 29 represents the sentence “Seth is a lawyer.” utilizing the present invention.

FIG. 30 represents the sentence “The boy pushes the car.” utilizing the present invention.

FIG. 31 represents the sentence “John is running.” utilizing the present invention.

FIG. 32 represents the sentence “John was chased.” utilizing the present invention.

FIG. 33 represents the sentence fragment “under the water” utilizing the present invention.

FIG. 34 represents the sentence fragment “at Kevin 's house” utilizing the present invention.

FIG. 35 represents the sentence fragment “to school” utilizing the present invention.

FIG. 36 represents the sentence fragment “over the big hill” utilizing the present invention.

FIG. 37 represents the sentence fragment “the black dog” utilizing the present invention.

FIG. 38 represents the sentence fragment “the big black dog” utilizing the present invention.

FIG. 39 represents a preferred embodiment of the present invention, wherein the red ball represents BE.

FIG. 40 represents a preferred embodiment of the present invention, wherein a red circle with -ing means an incomplete action.

FIG. 41 represents a preferred embodiment of the present invention, wherein a red circle with -ing and a graphical indicator indicates the direction or time of the action.

FIG. 42 represents two forms of a past tense action verb in a preferred embodiment of the present invention.

FIG. 43 represents a line of verb actions in a preferred embodiment of the present invention.

FIG. 44 represents a simple play illustrating more complicated verb structures, like the past perfect tense in a preferred embodiment of the present invention.

FIG. 45 represents a simple play illustrating verb structures, like the past tense in a preferred embodiment of the present invention.

FIG. 46 represents a simple play illustrating a more complicated verb structures, like the past progressive perfect tense in a preferred embodiment of the present invention.

FIG. 47 represents past tense passive voice in a preferred embodiment of the present invention.

FIG. 48 represents future tense in a preferred embodiment of the present invention.

FIG. 49 represents future tense in a preferred embodiment of the present invention.

FIG. 50 represents future progressive tense in a preferred embodiment of the present invention.

FIG. 51 represents the use of an auxiliary verb in a preferred embodiment of the present invention.

FIG. 52 represents the future perfect tense in a preferred embodiment of the present invention.

FIG. 53 represents the future progressive tense in a preferred embodiment of the present invention.

FIG. 54 represents the future perfect progressive tense in a preferred embodiment of the present invention.

FIG. 55 represents a past tense verb in a preferred embodiment of the present invention.

FIG. 56 represents the use of a negative in a preferred embodiment of the present invention.

FIG. 57 represents a past tense verb in a preferred embodiment of the present invention.

FIG. 58 represents the use of a negative in a preferred embodiment of the present invention.

FIG. 59 represents a past perfect verb tense in a preferred embodiment of the present invention.

FIG. 60 represents the use of a negative in a preferred embodiment of the present invention.

FIG. 61 represents a determiner and a noun in a preferred embodiment of the present invention.

FIG. 62 represents a prepositional phrase utilizing a preferred embodiment of the present invention.

FIG. 63 represents a sentence in the present tense in a preferred embodiment of the present invention.

FIG. 64 represents a sentence in the past tense in a preferred embodiment of the present invention.

FIG. 65 represents a finished action verb in a preferred embodiment of the present invention.

FIG. 66 represents an unfinished action verb in a preferred embodiment of the present invention.

FIG. 67 represents a sentence map utilizing the present invention.

FIG. 68 represents a noun of the name variety in a preferred embodiment of the present invention.

FIG. 69 represents a noun of the thing variety typically accompanied by a determiner in a preferred embodiment of the present invention.

FIG. 70 represents a decision tree to develop understanding of when to use a noun of the name variety versus a noun of the thing variety.

FIG. 71 represents a simple sentence introducing a present verb and an adjective in a preferred embodiment of the present invention.

FIG. 72 represents a question utilizing the present invention.

FIG. 73 represents a sentence utilizing a preposition and a prepositional phrase containing a noun of the place variety in preferred embodiment of the present invention.

FIG. 74 represents a question from Lesson Plan 5 in a preferred embodiment of the present invention.

FIG. 75 represents a sentence map illustrating the use of is and are in a preferred embodiment of the present invention.

FIG. 76 represents a question from Lesson Plan 6 in a preferred embodiment of the present invention.

FIG. 77 represents a sentence map illustrating the use of is and was in a preferred embodiment of the present invention.

FIG. 78 represents a question from Lesson Plan 7 in preferred embodiment of the present invention.

FIG. 79 represents a variant activity sentence from Lesson Plan 7 in a preferred embodiment of the present invention.

FIG. 80 represents a second variant activity sentence from Lesson Plan 7 in a preferred embodiment of the present invention.

FIG. 81 represents a sentence map illustrating the use of are and were in a preferred embodiment of the present invention.

FIG. 82 represents a question from Lesson Plan 8 in a preferred embodiment of the present invention.

FIG. 83 represents a variant activity sentence from Lesson Plan 8 in a preferred embodiment of the present invention.

FIG. 84 represents utilizing has as a verb in a sentence without action in a preferred embodiment of the present invention.

FIG. 85 represents a variant activity sentence from Lesson Plan 9 in a preferred embodiment of the present invention.

FIG. 86 represents second a variant activity sentence from Lesson Plan 9 in a preferred embodiment of the present invention.

FIG. 87 represents a question from Lesson Plan 9 in a preferred embodiment of the present invention.

FIG. 88 represents utilizing have as a verb in a sentence without action in a preferred embodiment of the present invention.

FIG. 89 represents a variant activity sentence from Lesson Plan 10 in a preferred embodiment of the present invention.

FIG. 90 represents a second variant activity sentence from Lesson Plan 10 in a preferred embodiment of the present invention.

FIG. 91 represents a question from Lesson Plan 10 in a preferred embodiment of the present invention.

FIG. 92 represents a sentence map utilizing an action verb in simple past tense in a preferred embodiment of the present invention.

FIG. 93 represents a question from Lesson Plan 11 in a preferred embodiment of the present invention.

FIG. 94 represents the shape of an action verb in simple past tense in a preferred embodiment of the present invention.

FIG. 95 represents a sentence map illustrating the function and place for adjectives in describing objects in a preferred embodiment of the present invention.

FIG. 96 represents a sentence map to aid in an activity for Lesson Plan 12 in a preferred embodiment of the present invention.

FIG. 97 represents a question from Lesson Plan 12 in a preferred embodiment of the present invention.

FIG. 98 represents a sentence map illustrating the past progressive verb structure in a preferred embodiment of the present invention.

FIG. 99 represents a question from Lesson Plan 13 in a preferred embodiment of the present invention.

FIG. 100 represents a question from Lesson Plan 13 in a preferred embodiment of the present invention.

FIG. 101 represents a sentence map illustrating the use of was and were with an -ing verb in a preferred embodiment of the present invention.

FIG. 102 represents a variant activity sentence from Lesson Plan 14 in a preferred embodiment of the present invention.

FIG. 103 represents a sentence map illustrating the use of either simple past or past progressive tense in a preferred embodiment of the present invention.

FIG. 104 represents a map illustrating a verb tense choice in a preferred embodiment of the present invention.

FIG. 105 represents a question from Lesson Plan 15 in a preferred embodiment of the present invention.

FIG. 106 represents a sentence map illustrating subject and object pronouns in a preferred embodiment of the present invention.

FIGS. 107 and 108 represent an activity from Lesson Plan 16 in a preferred embodiment of the present invention.

FIG. 110 represents a question from Lesson Plan 16 in a preferred embodiment of the present invention.

FIG. 111 represents a sentence map illustrating subject pronouns in a preferred embodiment of the present invention.

FIG. 112 represents a sentence map reinforcing the use of pronouns in a preferred embodiment of the present invention.

FIG. 113 represents a variant activity sentence from Lesson Plan 18 in a preferred embodiment of the present invention.

FIG. 114 represents a second variant activity sentence from Lesson Plan 18 in a preferred embodiment of the present invention.

FIG. 115 represents a sentence map illustrating possessive nouns in a preferred embodiment of the present invention.

FIG. 116 represents a variant activity sentence from Lesson Plan 19 in a preferred embodiment of the present invention.

FIG. 117 represents a question from Lesson Plan 19 in a preferred embodiment of the present invention.

FIG. 118 represents a sentence map illustrating the use of possessive nouns and pronouns in a preferred embodiment of the present invention.

FIG. 119 represents a variant activity sentence from Lesson Plan 20 in a preferred embodiment of the present invention.

FIG. 120 represent a second variant activity sentence from Lesson Plan 20 in a preferred embodiment of the present invention.

### DETAILED DESCRIPTION OF THE INVENTION

The present invention is a manipulative visual language tool and method for improving the literacy skills of students. The tool comprises a series or set of two or three-dimensional shapes, further modified by color, size, and graphical symbols. The present invention is preferably applied to elementary schools, as well as institutions of secondary education. The most preferred embodiment of the present invention comprises the present tool to teach the English language to deaf students.

The present invention is a reaction to traditional ways of teaching English grammar, which has been almost exclusively presented through text. There is a place for this approach, but it needs to be supplemented, because quite simply, using words to explain words can be a baffling approach if words are the problem. Many deaf adults have only bad memories of this kind of approach. The present invention enables students to see how the basic parts of English grammar work together, to literally get their hands on grammar. The present invention helps to make essential concepts stick.

It is true that deaf students are visual learners, but it can be said also that most people are visual learners. Any modern computer program is recognition of this fact: most working programs display a large quantity of visual symbols on screen. I can count at least 60 such symbols around the screen for the word processing program I am using now to type this paper. Spell check has an ABC over a check, paste is a little brush, cut is a pair of scissors, “save” a computer disk. At first sight all these symbols can seem daunting and confusing. But after a few touches on each symbol it all soon becomes a snap. There is a fine logic at work here, a logic that is expressed in a clear and visual way. Pre-school children are becoming computer literate, and often teach themselves, something that would not have been possible with the previous generation of computers. Likewise, with the present invention we present our students with a system of symbols. But there is a clear logic to the system, and our students can discover the logic behind the system because it is so visual and tactile. The results so far are extremely encouraging. After using the present invention, it is hard to imagine how we could teach the complexities of grammar without a logical, symbolic and visual approach.

The following terms are defined for purposes of the present invention: “Language” is the characteristic mode of arranging words as an expression of ideas by writing, or any other instrumentality. Language is a system of communication consisting of a set of small parts and a set of rules, which decide the ways in which these parts can be combined to produce messages that have meaning. A language is typically made up of the grammatical forms of speech, which are arranged as words, terms, phrases or symbols which each have meaning.

“Syntax” for purposes of the present invention is the grammatical arrangement of words in a sentence or, in other words, that part of grammar, which treats of the construction of sentences—the due arrangement of words in sentences in their necessary relations, according to established usage in any language. “Grammar” means the study or use of the rules about how words change their form and combine with other words to make sentences.

The “words” of a language are classified into grammatical parts of speech, which indicate the function of a word and its usual placement in a group of words in the given language. These grammatical parts of speech typically are sub-divided into further varieties of parts of speech. For example, a verb is a particular grammatical part of speech. As a verb, it denotes action and typically follows a subject in a sentence. Verbs are divided into several varieties or tenses, such as simple past, simple present, and simple future tenses.

The present invention attempts to provide models for students, deaf, as well as hearing, to assimilate language syntax. In a classroom using the present invention, nouns, verbs, adjectives or other grammatical elements of a language come to life. The main parts of speech are visible everywhere in two and three dimensions, and by shape, size, and color. This means, for example, that students are not just told about verb tenses. Instead they can see, feel, and touch them. If they do not know whether to use “was,” “is,” or “were”, they can go and get their hands on these verbs. In a classroom where nouns, verbs in their many guises, adverbs, adjectives, are all visible and tactile, the language becomes a real experience. Students develop a strong sense of the structures of the language reading and writing skills inevitably improve.

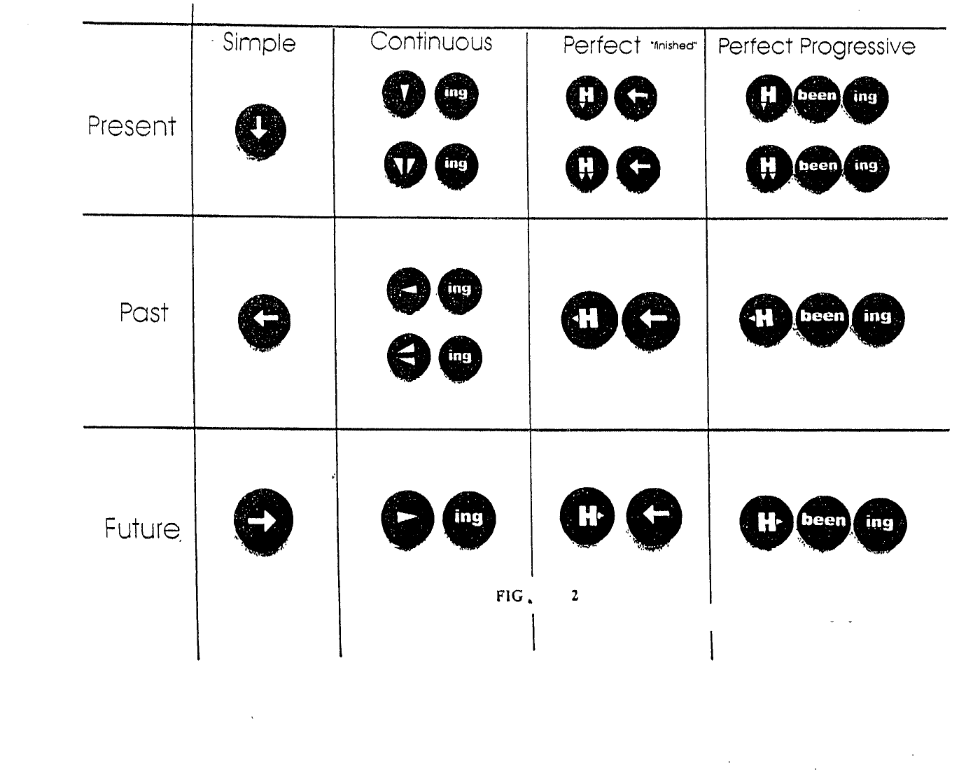

To accomplish this, the present invention uses master shapes. The bold master shapes, which may be colored, are intriguing to someone who has no experience with this visual approach. The master shapes may be introduced to the students with stories. Each master shape represents a single grammatical part of speech. Since languages are composed of more than one part of speech, in a preferred embodiment, the tool of the present invention will comprise a set, in order to represent all the myriad parts of speech of speech of the language of interest. A preferred embodiment of the present invention is illustrated in FIG. 3.

These master shapes are further modified by graphical indicators to convey additional grammatical information to students. For example, asking for a vegetable in a restaurant does not provide enough information to the waiter. While a request for a vegetable narrows down the options, the chef requires more information such as the kind of vegetable and how it should be cooked. What kind of vegetable? How do you want it cooked? So it is with the master shape. As a way of giving the word or grammatical form a classification, it is a great start, but we need to know more about it, in terms of the way the grammatical form has to be written, and also on a conceptual level. That is why we developed graphical indicators, also referred to herein as variants, within and around the master shapes.

Different grammatical forms are defined within the master shape by the addition of an indicator. For example, a purple isosceles triangle may be used to represent all pronouns. Raised “eyebrows” may be added to represent subject pronoun, such as she, he, it, they, we, it, you, I. Frowning “eyebrows” may be added to represent object pronoun: her, him, it, them, us, you, me. A “thumb” may be added to represent possessive pronoun: her, his, its, their, our, your, my. The graphics added to the master shape give a definition of the grammatical forms exact meaning. For example, we can clearly convey verb tenses, and different forms of the auxiliary verbs “to be”, “to have” and “to do”. Students can see what verb tenses look like and, very importantly, they can see what they mean. Also, many older students are unsure of the correct order to use multiple adjectives in a sentence for example, fat big pig or big fat pig. The present invention provides nine categories of adjectives by adding a graphic to the master shape. A recommended order for the graphical indicators is disclosed. Once students have memorized these graphics, they are able to use multiple grammatical forms in a sentence.

The present invention uses two and three-dimensional materials to display the shapes and graphics. Three dimensional wooden shapes that are a good size for handling. For work on a set structure, students can organize and sequence the shapes themselves on their desks. Students can have a set on their desks when they are writing sentences to practice a particular structure. A sample set of materials according to a preferred embodiment of the present invention is pictured in FIG. 3.

The present invention also utilizes two-dimensional colored shapes, made from strong, colored plastics, which have a magnetic backing. The visual impact of these colors against a white or even black background is striking. Students use these to symbolize sentences on the whiteboard, illustrated in FIG. 3, or with texts projected by overhead projector. In addition, the grammatical forms of the present invention may be displayed on banners or used in films.

The Shapes

The most striking feature of the present invention is the use of shapes, especially colored shapes to represent the grammatical forms of the language. Enter a classroom using the present invention, and the bold and colorful shapes will be intriguing to someone who has no experience of this visual approach. Each shape represents a different grammatical form or part of speech. Geometric shapes are preferred. In a preferred embodiment, black equilateral triangles may represent nouns, red circles may represent verbs, purple triangles may represent pronouns, green crescents may represent prepositions, and blue equilateral triangles may represent adjectives.

However, these shapes alone, although very useful, are not able to convey enough information to students. Each grammatical form or part of speech is made up of sub-groupings. For example, there are several different forms of nouns, such as names, things, place, and possessive nouns. Each variety may be clearly and strongly defined within their ‘master’ shape by a designated graphical indicator. The graphical indicator may be a symbol, letter, shape or pattern. One graphical indicator is preferably assigned to represent each grammatical variety.

In a preferred embodiment of the present invention, the preferred language may be English. However, any language, which consists of at least two grammatical parts or forms of speech and varieties of these grammatical parts of speech, may be taught by the tool and method of the present invention. Specifically contemplated are German, Spanish, French, Romanian, and Italian, as well as unspoken languages, such as Latin and Greek. Non-romance based languages such as Russian, Japanese, Chinese, to name a sampling, are contemplated for use with the present invention.

Grammatical Parts of Speech:

Languages are comprised of grammatical parts of speech. In a preferred embodiment of the present invention, the language is English, and the grammatical parts of speech include nouns, pronouns, verbs, adverbs, adjectives, conjunctions, prepositions, gerunds, negatives or determiners, and the like.

Nouns

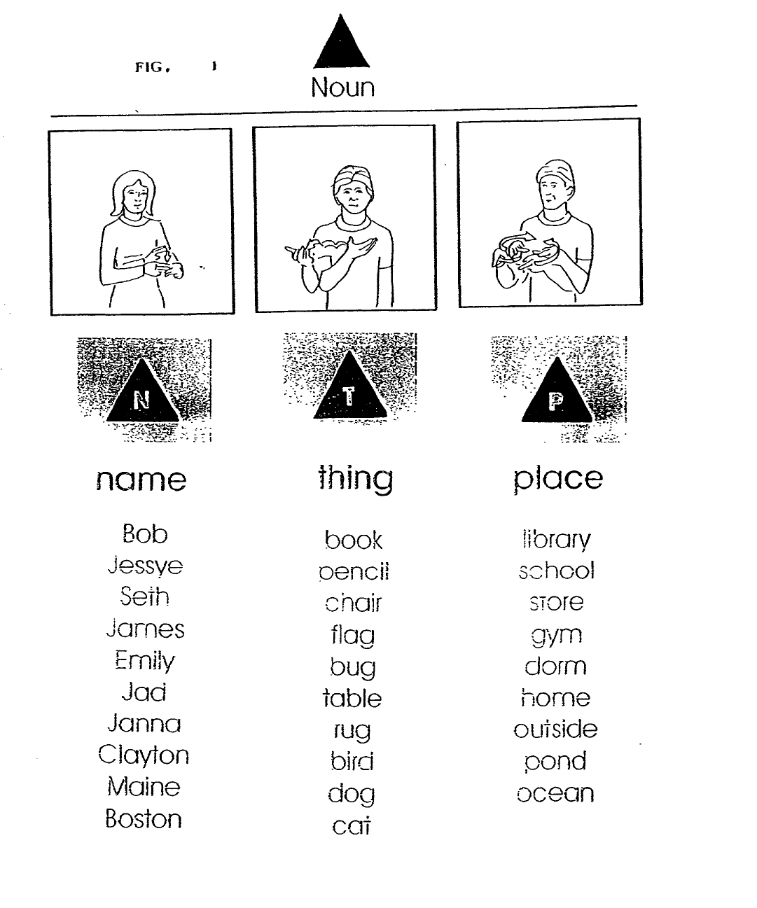

The grammatical form or part of speech, noun, may be represented by any colored shape. The identical shape, size, and color is preferably used to represent only nouns. Nouns are then classified into various varieties, for example, to represent a name, a place, a thing, or a possessive noun. In a preferred embodiment of the present invention, nouns may be represented by a large black triangle, then further classified into various shapes combined with letters to represent a name (a triangle with N), a place (a triangle with P), a thing (a triangle with T), or a possessive noun (a triangle with a thumb), as illustrated in FIG. 1.

Verbs

The grammatical form or part of speech, verb, may be represented by any colored shape. The identical shape, size, and color is preferably used to represent only verbs. Verbs are then classified into various varieties, referred to herein as tenses, for example, simple, continuous, perfect and perfect progressive. In a preferred embodiment of the present invention, verbs are represented in the preferred embodiment by circles, most preferably red. Verbs are further classified into varieties or tenses, such as present, past, future, which may be divided into additional varieties, such as continuous, perfect and perfect progressive. One preferred embodiment of verbs is illustrated in FIG. 2

Determiners

The grammatical form or part of speech, determiner, may be represented by any colored shape. The identical shape, size, and color is preferably used to represent only determiners. Determiners are then classified into various varieties, such as the, a, an, some, this, #. There are three important kinds or varieties of determiners to know. The first type of determiners are articles, such as a, an, and the. The second type of determiners are possessives, such as my, your, its, her, his, our, their. The third type of determines are adjectives of amount, such as some, any, much, each, enough. Determiners are typically used before a noun. In a preferred embodiment of the present invention, Determiners, such as the, a, an, some, this, #, may be represented by light blue, small triangles. This triangle appears most often with the T black triangle (The box), not with the N triangle.

Adjectives

The grammatical form or part of speech, adjective, may be represented by any colored shape. The identical shape, size, and color is preferably used to represent only adjectives. Adjectives are then classified into various varieties. There are nine categories or varieties of adjectives. These categories may also include a preferred order. In a preferred embodiment of the present invention, adjectives may be represented by medium sized, darker blue triangles, each with a graphic within the blue triangle, as illustrated in FIG. 4 (two-dimensional) and FIG. 5 (three dimensional). FIG. 4 also indicates the preferred order in which adjectives may be used, when more than one adjective is used in the preferred embodiment of the present invention.

Pronouns

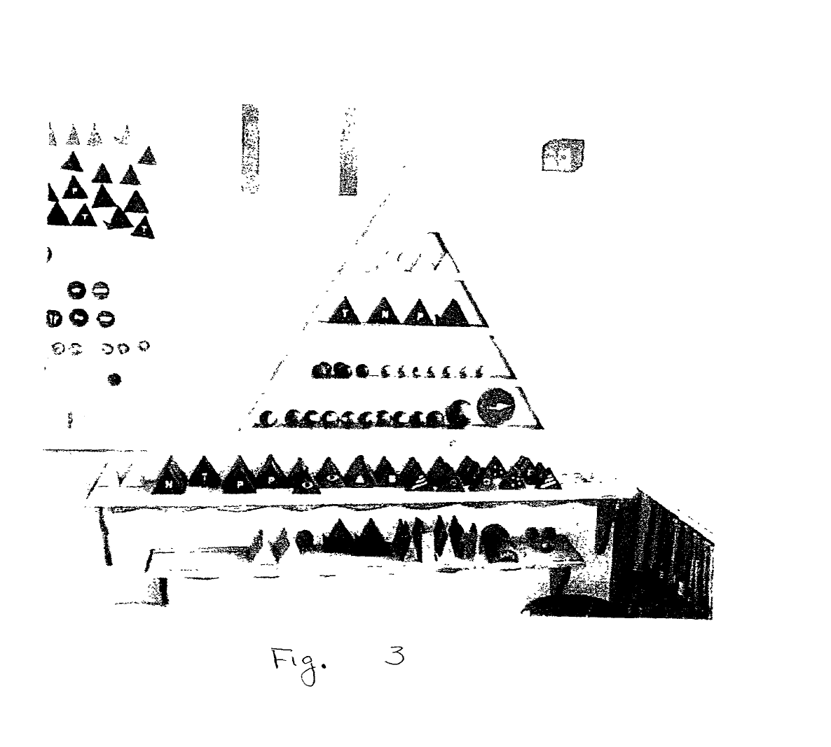

The grammatical form or part of speech, pronoun, may be represented by any colored shape. The identical shape, size, and color is preferably used to represent only pronouns. Pronouns are then classified into various varieties, such as subject pronouns, such as she, he, it, they, we, you, I, object pronouns, such as her, him, it, them, us, you, me, or possessive pronoun, such as her, his, its, their, our, your, my. In a preferred embodiment of the present invention, pronouns may be represented by purple isosceles triangles. A purple isosceles triangle with raised eyebrows may represent a subject pronoun, such as she, he, it, they, we, you, I. The frowning ‘eyebrows’ may represent an object pronoun: her, him, it, them, us, you, me. The ‘thumb’ may represent possessive pronoun her, his, its, their, our, your, my. One embodiment of pronouns is illustrated in FIG. 6 (two-dimensional) and FIG. 7 (three-dimensional).

Adverbs

The grammatical form or part of speech, adverb, may be represented by any colored shape. The identical shape, size, and color is preferably used to represent only adverbs. Adverbs are then classified into various varieties. There are several types of adverbs.

Adverbs of Place

Adverbs of place answer the question where: anywhere, around, away, down, everywhere, far, here, in, inside, near, nearby, nowhere, out, outside, somewhere, there, up. They are generally placed after the verb or after the direct object, for example, after the verb (I looked everywhere) or after the direct object (We bought our car here.). Other examples include “I'm going home.” and “His mother came out of the house and the boy ran towards her.”

Adverbs of Time

Adverbs of time answer the question when. Generally, the adverb of time is placed at the beginning or the end of a sentence. For example, at the beginning (Then we went to bed.), or at the end (He is arriving soon.) Yet and still are adverbs of time. YET is placed at the end of the sentence or after not. Still is usually placed before the verb but after the verb to be.

Adverbs of Manner

Adverbs of manner answer the question how. Adverbs of manner modify (change) verbs. They are generally placed after the direct object (They speak Italian badly.) or after verb (Jim swims well.).

Adverbs of Degree

Adverbs of degree tell us about the intensity, strength, power, or degree of an action. Adverbs often add something to the verb. They can tell us about how the verb acts. Adverbs can also describe adjectives or even other adverbs. Some common adverbs of degree include almost, nearly, quite, just, too, enough, hardly, scarcely, completely, clearly, obviously. Adverbs of intensity, degree or quantity are generally placed before the adjective or adverb being modified, before the adjective, before the main verb. For example, “He had hardly arrived before they started arguing”, or “They are completely exhausted from the trip”.

Interrogative Adverbs

The interrogative adverbs are: WHY, WHERE, HOW, WHEN, HOW MUCH. For example, Why are you so late? Where is my passport? How are you? How much is that coat?

Adverbs of Frequency

Adverbs of frequency answer the question how often? Some common adverbs of frequency include always, often, frequently, from time to time, occasionally, sometimes, seldom, rarely, never. Generally, they are placed after to be when to be is not an auxiliary (He is always late for work.), before the verb in simple tenses (She often visits her mother.), after the first auxiliary in compound tenses (Jack has never been to Italy.), at the beginning or end of a sentence (They are always at home, Sometimes we stay at home and watch television, They go to the theatre often.)

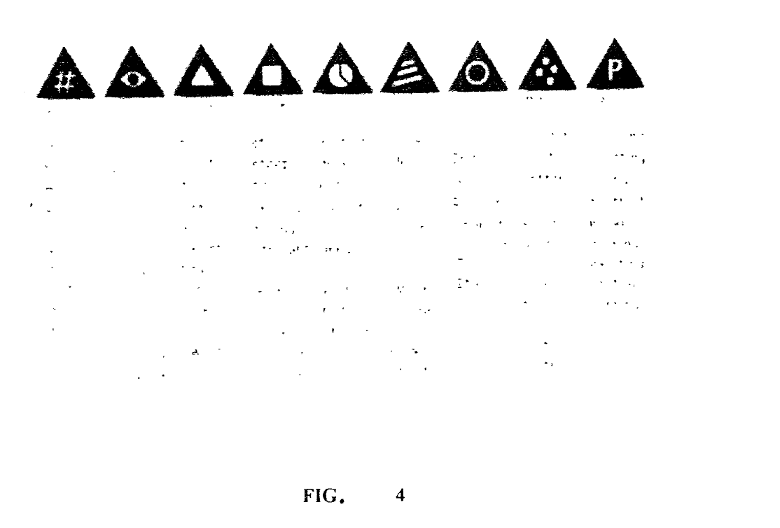

In a preferred embodiment of the present invention, adverbs may be represented by an orange circle and a preferred embodiment is illustrated in FIG. 8.

Prepositions

The grammatical form or part of speech, preposition, may be represented by any colored shape. The identical shape, size, and color is preferably used to represent only prepositions. Prepositions are then classified into various varieties. There are several varieties of prepositions.

Preposition with Verbs of Transport

It is important for you to know about how to use preposition with verbs of transport such as to travel, to walk, to drive, to go, to fly, to ride, to run. Examples: I traveled from Maine to New Hampshire, John drove from Boston to Portland, Jon arrived in Brazil. We use prepositions with verbs of transport to describe the place we are leaving, the place to which we are going, and the end of travel.

Preposition “On”

Users of American English think of streets as flat surfaces (like tables), floors as flat surfaces (like tables), and islands as flat surfaces (like tables). We put things on tables; we use on with streets, floors, and islands.

Preposition “In”

Many prepositions are really idiomatic. An idiom is an expression, which really has no explanation. People use idioms by habit. Students must memorize the idioms and acquire the habit of using them correctly. Sometimes we can help you remember many of the correct prepositions by giving you word-picture to keep in your mind. These word-pictures to keep your mind. These word-pictures will also help you understand why the prepositions seem correct to user of English. Now I am giving you an empty cardboard box. I want you to think there is nothing inside the box. I am asking you to put something inside box such as putting the word “cities, countries, states, and continents in this box. It is good idea to remember that you put things in boxes. Therefore, we use “in” with cities, countries, states, and continents. For example, John lives in England, I met my friend in Europe.

In a preferred embodiment of the present invention, a green crescent may represent a preposition. In the preferred embodiment picture in FIG. 9, one symbol may be used to represent all varieties of prepositions.

Conjunctions

The grammatical form or part of speech, conjunction, may be represented by any colored shape. The identical shape, size, and color is preferably used to represent only conjunctions. Conjunctions are connective words, such as and, but, because. In a preferred embodiment of the present invention, a pink rectangle may represent a conjunction, such as and, but, because.

Negatives

The grammatical form or part of speech, negative, may be represented by any colored shape. The identical shape, size, and color is preferably used to represent only negatives. Negatives are then classified into various varieties. In a preferred embodiment of the present invention, a black circle may represent the negative not, as illustrated in FIG. 10.

Various materials may be used to present the patterns of the present invention. One embodiment utilizes two-dimensional shapes made from strong, colored plastics, which have a magnetic backing. The visual impact of these colors against a white or even black background is striking. Students may use these to symbolize sentences on the whiteboard or with texts projected by overhead projector. In the hands of an imaginative teacher, the two and three-dimensional shapes can be used in many creative and meaningful ways. In another embodiment, three-dimensional shapes that are a good size for handling are utilized. For work on a set structure, students can organize and sequence the shapes themselves on their desks. Students may utilize a set on their desks when they are writing sentences to practice a particular structure.

In another embodiment, the present invention may be utilized in poster form. Sequences of shapes may be displayed to show common English patterns, rather than printed advice for the students to formulate their understanding of grammar. Students may see that, before nouns, they usually put an article, that an article follows prepositions, and that a noun and subject are followed by verbs, even if the subject itself is ‘doing’ nothing, for example, the spoon is in the cup. It is our hope that these patterns on permanent display will help our students to assimilate basic structures, consciously or unconsciously.

Another embodiment of the invention comprises a banner called the Sentence Map. It is a guide for our students in their writing. It looks like a road map. Students can trace a line from left to right, selecting the elements they will need to write a simple and clear sentence. There are several options along the road, but on this road there is no way to bypass the first verb! We designed this sentence map for those students who are reluctant writers, and it is a very popular tool. If students can master the structures within the map, they will have a marvelous foundation, and will be ready to learn more complicated structures through more direct instruction.

Reading

The present invention is particularly strong in helping students with writing, but we also use it in reading activities. One exercise is for students to “analyze and symbolize” either sentences or blocks of texts. With colored pencils they seek out a particular structure and mark above the words appropriately. It is a simple exercise in code breaking, and is a popular activity with our students.

Sometimes, in-group reading exercises when we have a projected text, we come across an unknown word. We can use the present invention to help narrow the options. For example: “Jane registered the car.” If a student does not know what registered means, we can set up the magnetized shapes for “Jane”, “the”, and “car”. It is a very positive sign if a student puts a symbol for a past tense verb over registered. This shows that the student does know some important information about the word. One game we play is to hide a word in our projected text, and students get a point for the right the present invention shape, and another point if they get the word right. A stronger understanding of syntax helps develop reading skills.

In addition to the tool, the present invention comprises a method for using the tool. The method teaches the grammar and syntax of a language by providing a manipulative visual language tool for teaching grammar and syntax of a language comprising at least one colored shape further comprising at least one graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech; and exposing at least one individual to said manipulative visual language tool. In a more detailed preferred embodiment, the method of teaching the grammar and syntax of a language comprises providing a manipulative visual language tool for teaching grammar and syntax of a language comprising at least one colored shape further comprising at least one graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech, exposing at least one individual to one of said at least one colored shape, exposing said individual to one of said at least one graphical indicator of said at least one colored shape, repeating the exposure of said individual to said at least one graphical indicator of said at least one colored shape until all of said at least one graphical indicator of said at least one colored shape have been exposed, exposing said individual to a second of said at least one colored shape, exposing said individual to one of said at least one graphical indicator of said second of at least one colored shape, repeating the exposure of said individual to said at least one graphical indicator of said second of at least one colored shape until all of said at least one graphical indicator of said second of at least one colored shape have been exposed, and repeating the above steps said individual has been exposed to all of said at least one colored shapes.

In other words, in a preferred embodiment, the individual wishing to learn the language is taught the grammatical parts of speech, such as noun, verb, etc. and the corresponding master shape. Next, the individual is taught the varieties of each part of speech, and the series of graphical indicators in combination with the master shape. This is repeated until the individual has learned all the grammatical parts of speech and varieties of the target language. The individual begins to learn syntax by arranging the master shapes to form sentences or simple phrases, followed by combination of sentences into paragraphs, stories and other literary works. In another embodiment, the individual may begin to learn syntax prior to completion of learning all the grammatical parts of speech. If a few key elements, for example, nouns and verbs are learned first, they individual can begin learning syntax immediately, allowing syntax rules to be learned at the same time additional grammatical parts of speech are learned. For example, if nouns and verbs are learned first and arranged in simple sentences, the addition of master shapes representing adjectives can be learned and practiced in sentences immediately.

The following examples are provided to illustrate the invention, especially the preferred embodiment.

### EXAMPLE 1

### Samples

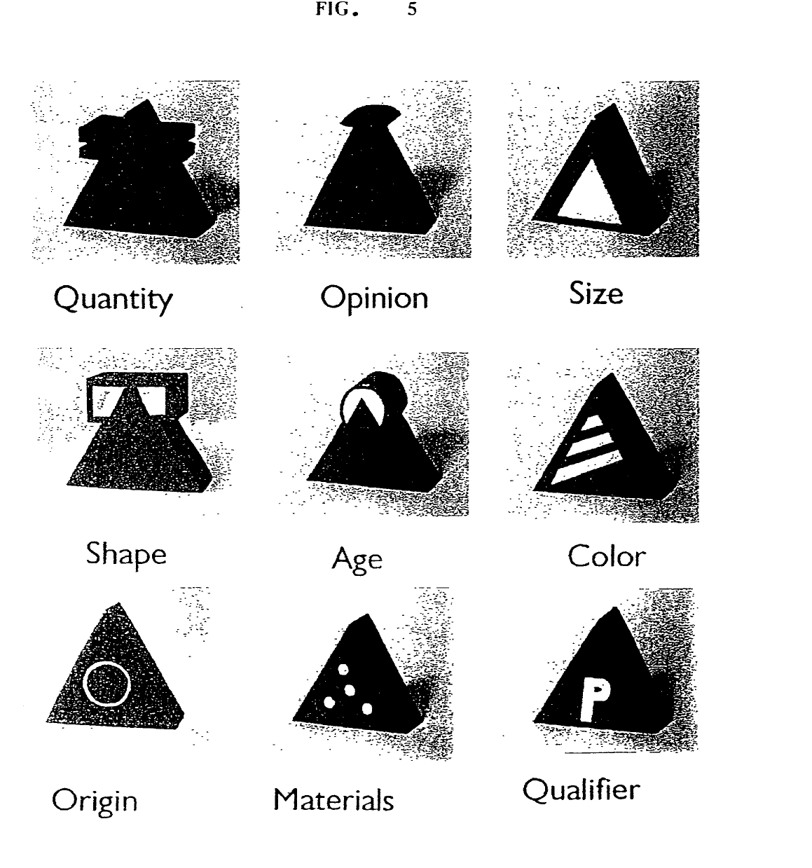

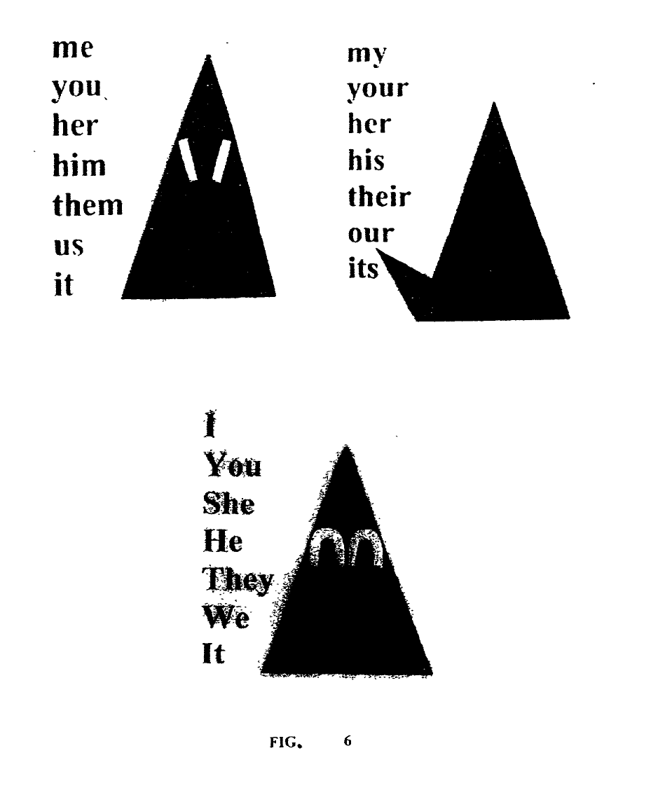

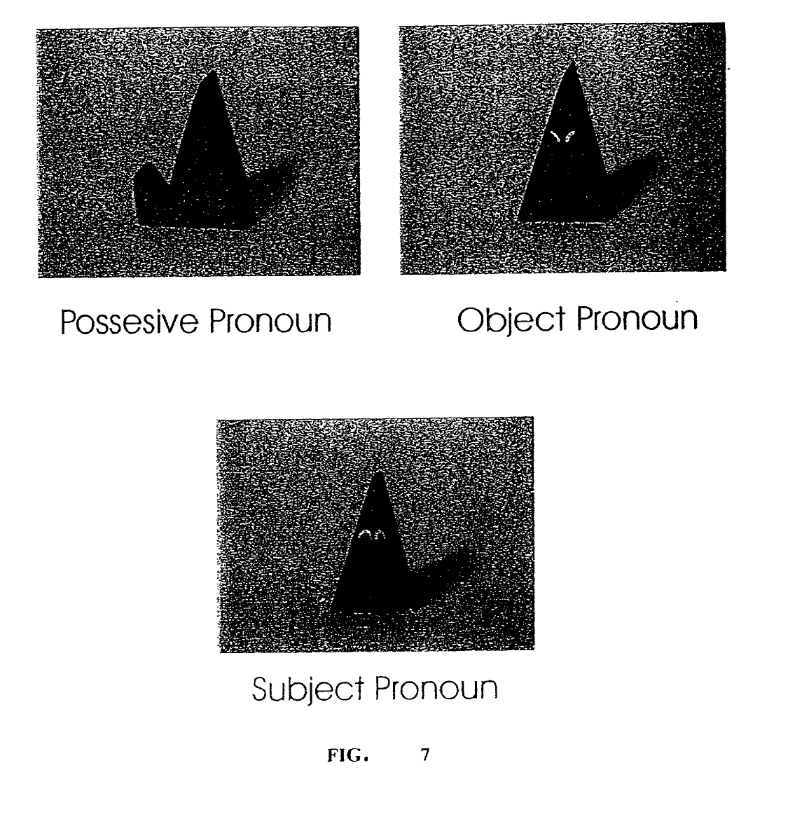

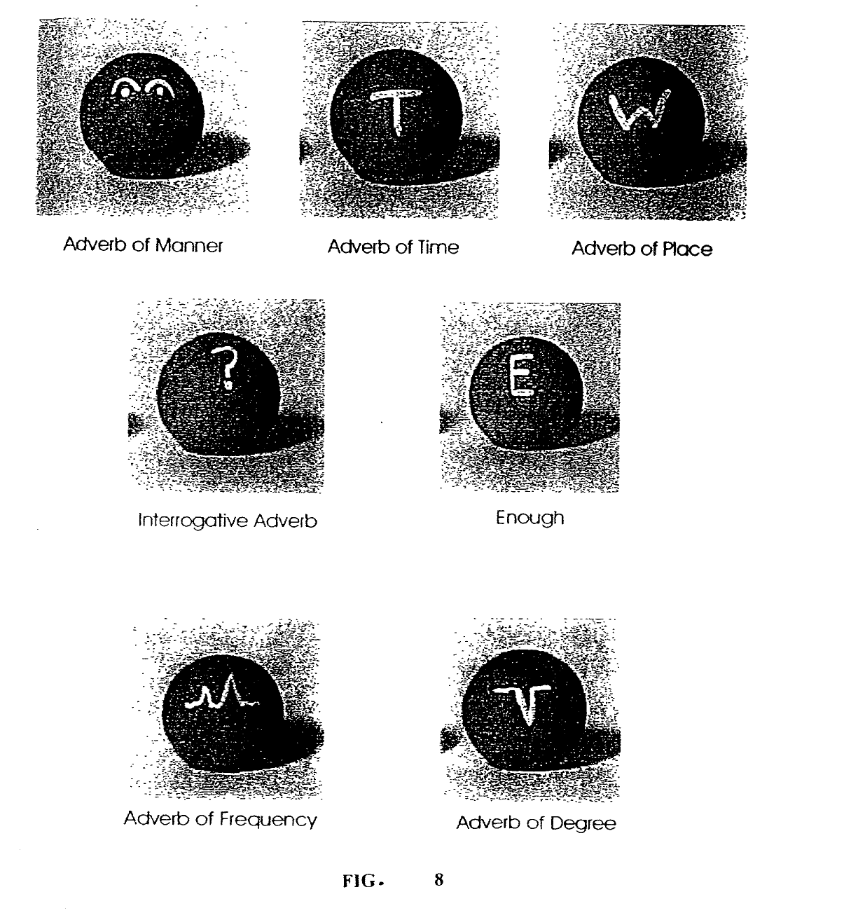

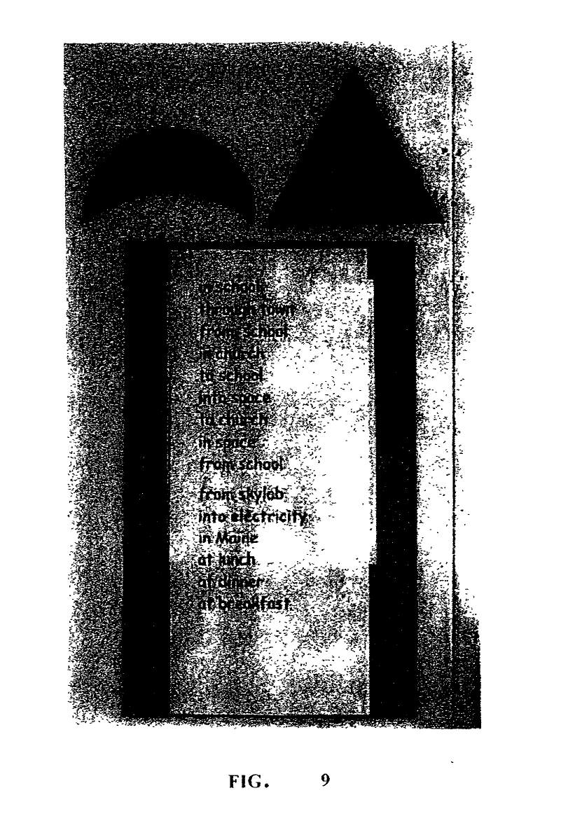

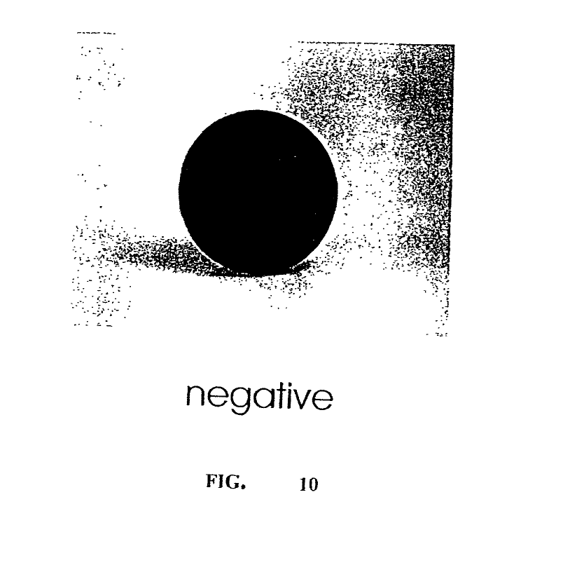

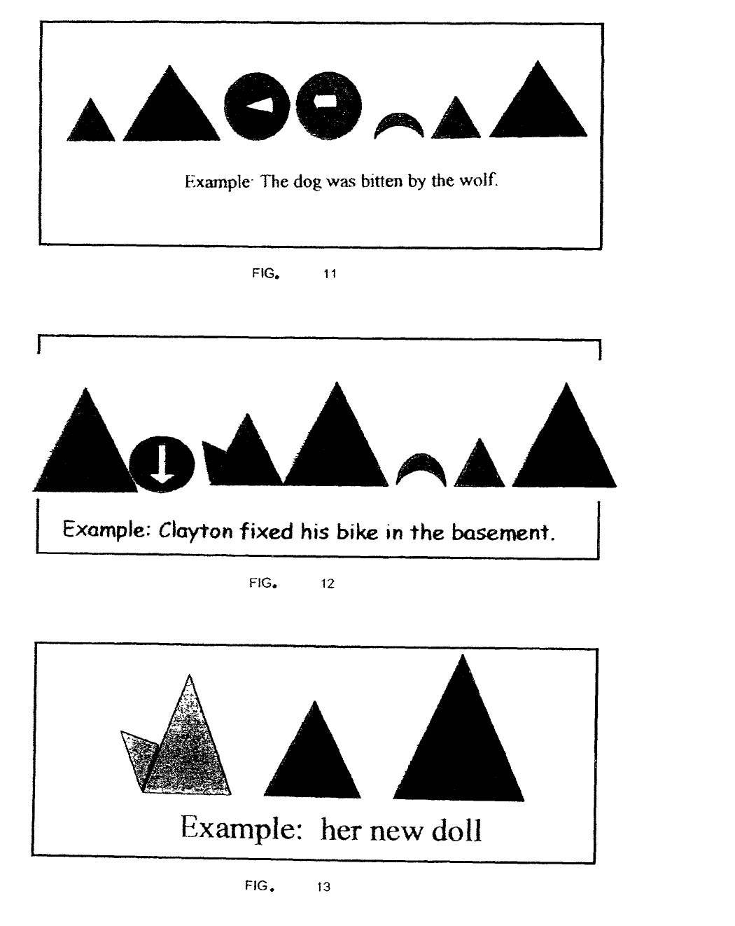

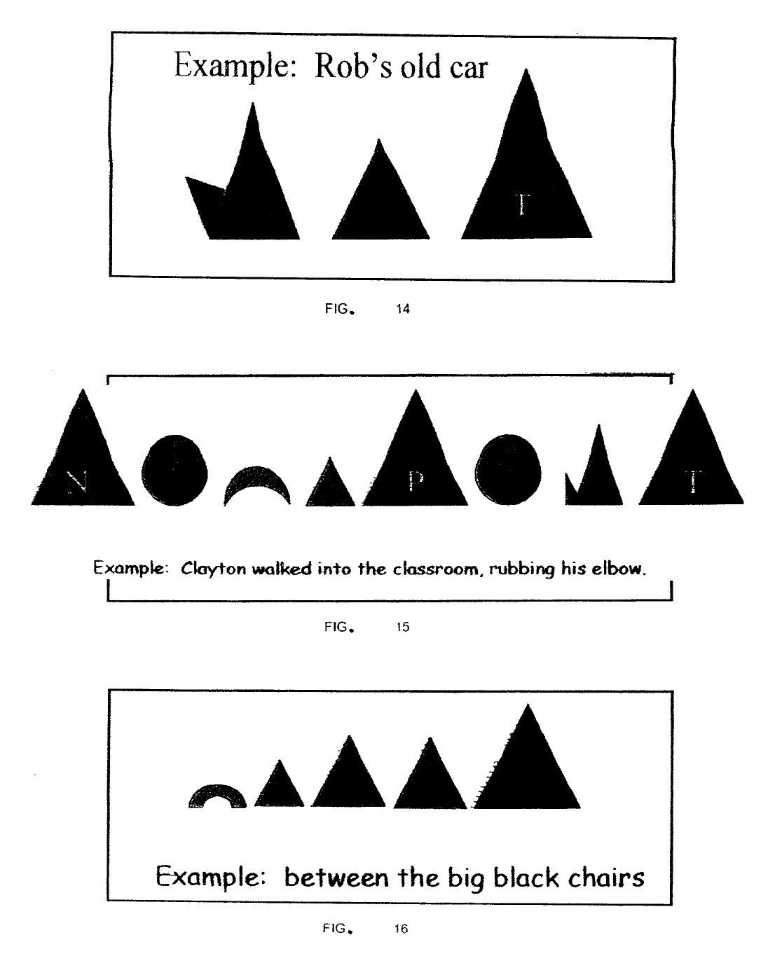

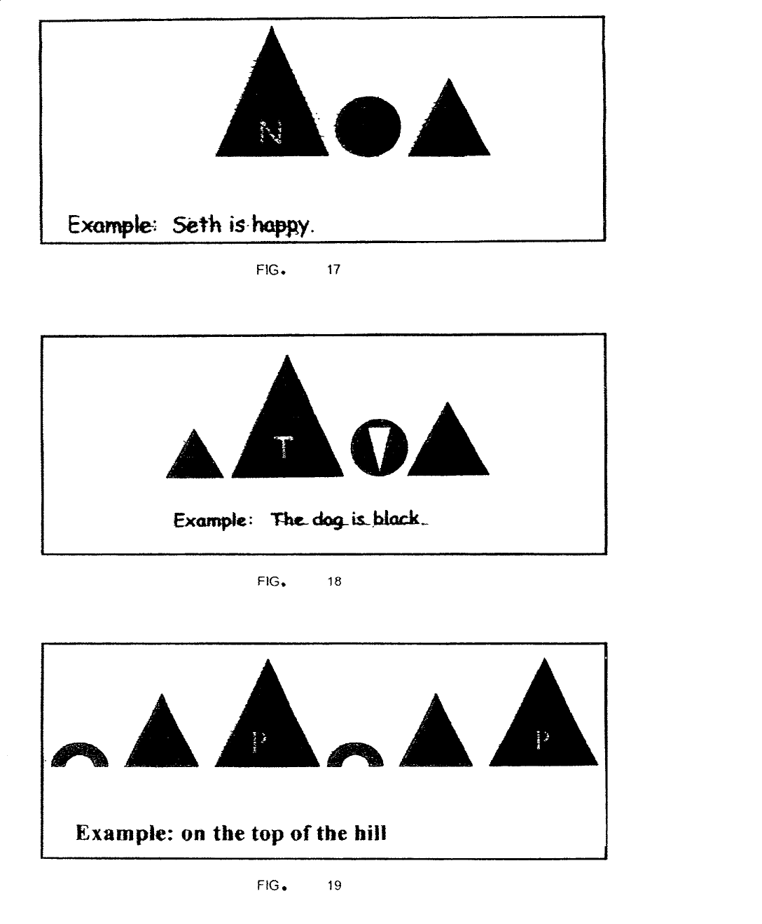

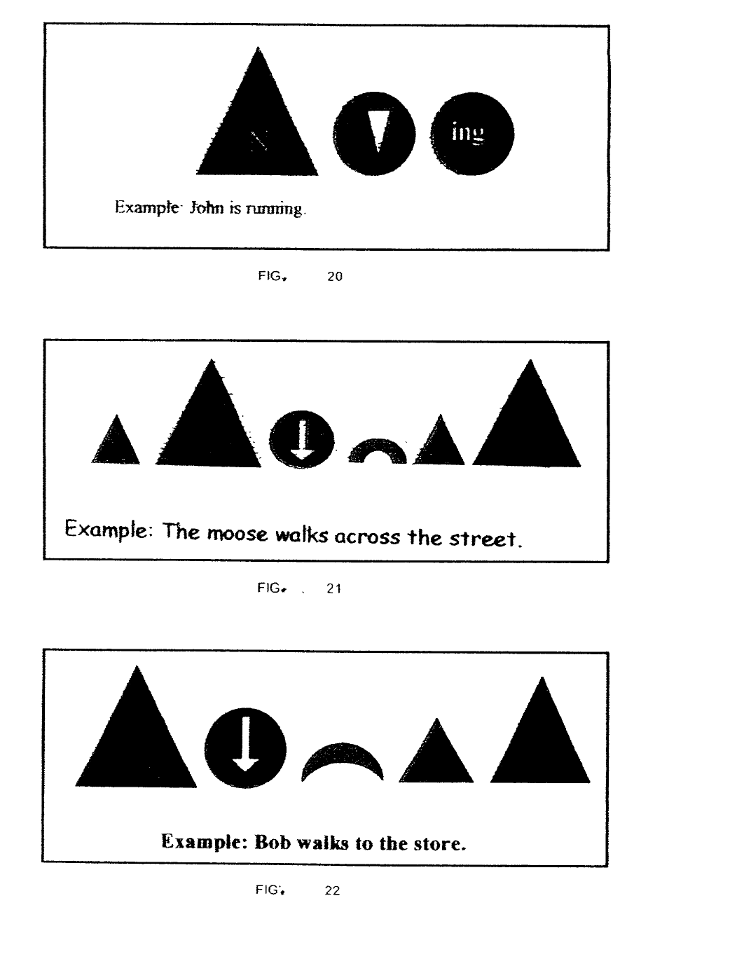

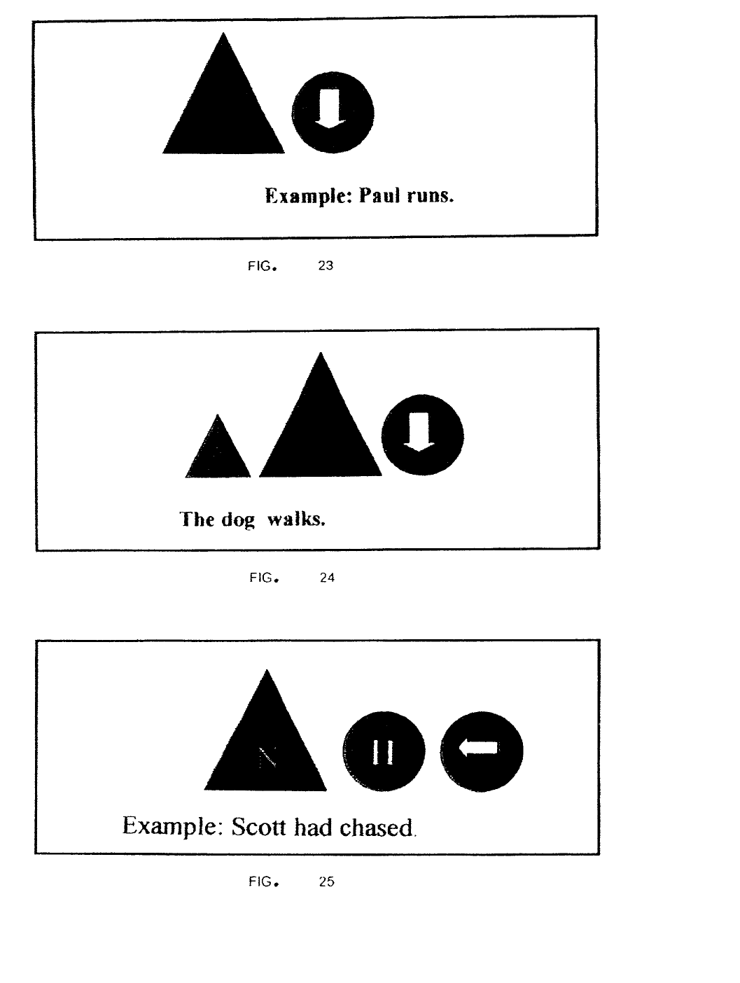

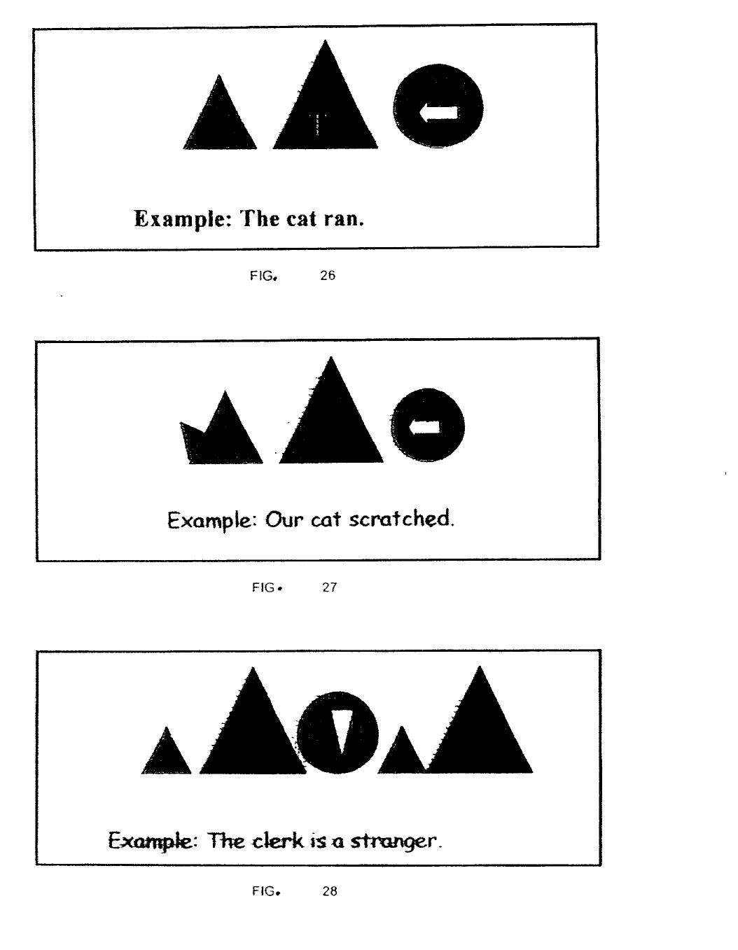

FIGS. 11-38 illustrate sentences utilizing the present invention.

### EXAMPLE 2

### Teaching Verbs

On one level, it is hard to convey the concepts behind different forms of verbs. Then if the concepts are understood, it is not always easy to know the correct way to write them. The present invention helps to develop a conceptual understanding of basic verb structure, and to visualize the way verbs have to be written.

A Little Devil Call BE

We start with basic structures and build up from there. It is important to proceed carefully, establishing the, concepts strongly at each stage. It is not easy to have a sequence for learning verbs and verb structure, but you have to start somewhere. We suggest starling with the verb to be. One of the most important concepts that needs to be learned is the fact that BE has many disguises. Students need to know that is, are, am, were, was, being, will be, and been all derive from the same verb, BE. In fact, they are the verb BE, in different forms. The English language has a host of demons, and perhaps this little word is the most mischievous devil of them all. It might be hard to say what the actual word BE means, but the word itself contributes decisively to meaning. We tell the students that BE is like a potato: whether it is made as a French fry, or a chip, or mashed, or baked, or roasted, it is still a potato. In the same way, was and am are . . . BE.

The red ball for BE in FIG. 39 is useful in showing this. With all the difficulties teachers have had in the past with the verb to be, it is nice at last to get our hands on the little devil! All the symbols for is, are, am, were, was, will be, are within this one shape, and rotating the ball changes the meaning.

We start by using BE in simple prepositional phrases. The cup is on the floor, the pencils are under the table, the books were in the refrigerator. It helps to establish the fact that every sentence needs a verb, even if the cup, the pencils and the books are ‘doing’ nothing. It also helps to give some meaning to the word BE in the minds of the students. Using real life examples, with short ‘plays’, and letting the students rotate the BE ball or the two-dimensional BE circle should be very helpful ways to learn the concepts.

At this stage we also introduce adjectival phrases, like Mark is sad, the boys are hungry, the teacher is busy, you will be. Once again, this establishes the need for a verb in every sentence, even when the subject is ‘doing’ nothing. Many imaginative in-class activities can be used to work on this concept. Continuing with the theme of verbs without action, this is a good time to introduce has and have—I have brown hair, John has a red car, Marie has a goldfish. This is a simple structure, and students see that every sentence still has a red circle.

At the next stage, the red circle or ball signifies action. The shape and the lively color are most appropriate for verbs. Verb tenses have traditionally been very hard to teach. The present invention verbs, in conjunction with lively and imaginative classroom activities can be a big help in understanding the concepts behind the tenses.

Going from the adjectival phrase and the prepositional phrase to the verb phrase, you move on to present progressive: Mary is jumping, Mark is sleeping, the boys are working. At this early stage, when asking students to write simple stories, we suggest that you treat the simple present with some caution for now—Mary jumps, Mark sleeps. It is a structure that at this stage of language development rarely appears in natural spoken English, and the concept behind it is rather advanced. For example, take the sentence “Jenny rides to work. This indicates the way jenny presently gets to work; but the action of riding itself is a completed action. While the simple present is not so common these days in storybooks, it is very common in textbooks: Scientists believe greenhouse gases cause global warming; Americans remember their Independence every July 4, and celebrate with fireworks.

Most stories and journal reports happen in the past, and we start by working on two tenses: past progressive and perfect tense. Looking at most reading books for young children, we see these two forms of the past tense occurring with the greatest frequency. We tell the students that the red circle with an arrow means completed, or ‘finished’ action. It does not matter which way it faces—left for past, forward for future, or down for present—on a conceptual level it signifies completed action. This is useful for irregular past tense verbs, like ran, swam, etc., because the concept remains constant despite the strange spelling irregularities.

The red circle with -ing means an incomplete action. FIG. 40 shows the way the two circles appear, the arrows around the circle below indicate the three possible positions. For teaching past tense verbs, this is an excellent place to start.

A Word About -ing

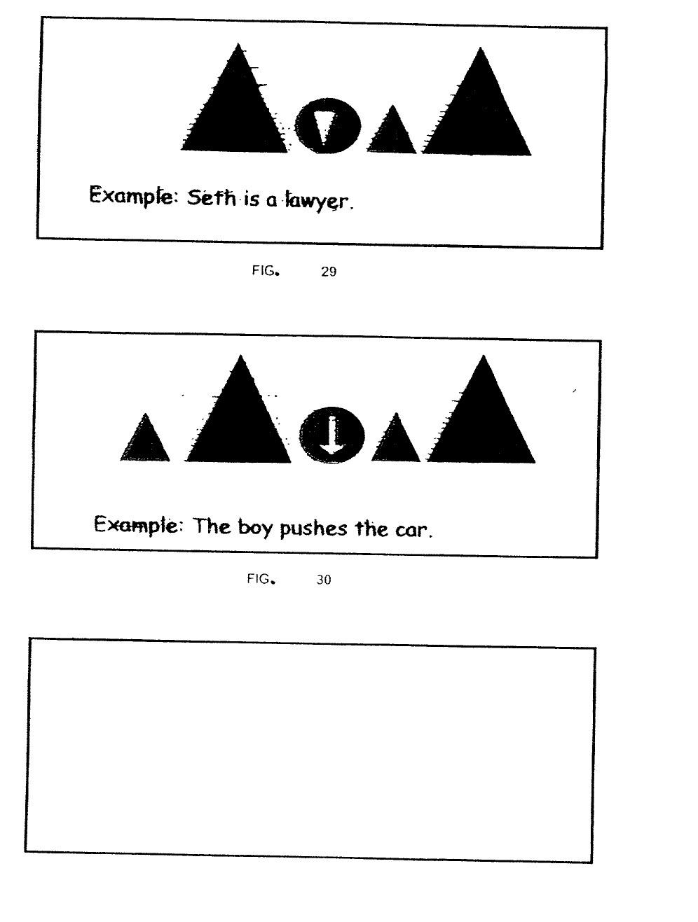

We have observed that some students get confused with a verb ending with -ing. Some seem to think that a word like walking shows a tense—usually the present—and does not need BE in front of it. It is important to show that there is no tense in the word walking at all. BE controls the tense. We liken it to a car: -ing is like the engine, constantly running, but not controlling the direction. BE is like the gearbox, and it decides the direction the car moves in and is illustrated in FIG. 41. Students can see no change in the -ing word, only BE changes. Once again, this is a good visual way to reinforce the concept.

We show the students that when they write a past tense action verb, they usually have two choices in FIG. 42. Students often leave out the verb to be when they use a verb ending with -ing, (Maria walking) or they might put BE with a perfect past tense verb, not meaning it as a passive verb: Maria was walked. It is important to stress the need to keep the verbs in FIG. 42 in their right places. This rule is broken with the passive voice, of course, but that should come later, when this concept is understood.

The Timeline

A timeline activity is a good way to help students visualize tenses. We often start by enacting a simple drama. For example, we could ask students to enact the following:

Michael entered the room. He was wearing a strange hat. He noticed Jane in the corner. She was working. He tapped Jane on the shoulder. He gave her the hat. She said, “thanks.” Michael left.

We film the plays with a movie camera, with a videotape inside. After the play, we pull about two and a half feet of the tape out of the camera, and cut it. Tape this to a whiteboard, and you have a bold, clear timeline. Students can see that the line represents events that occurred in the past, and can easily picture and sequence those events. Along this line, you can add the circles and list the verbs. The actions can be seen and almost measured along this line, illustrated in FIG. 43. Prepositional and adjectival phrases can be added. But we try and keep it simple, and to anticipate the verbs that will come up.

Past Perfect

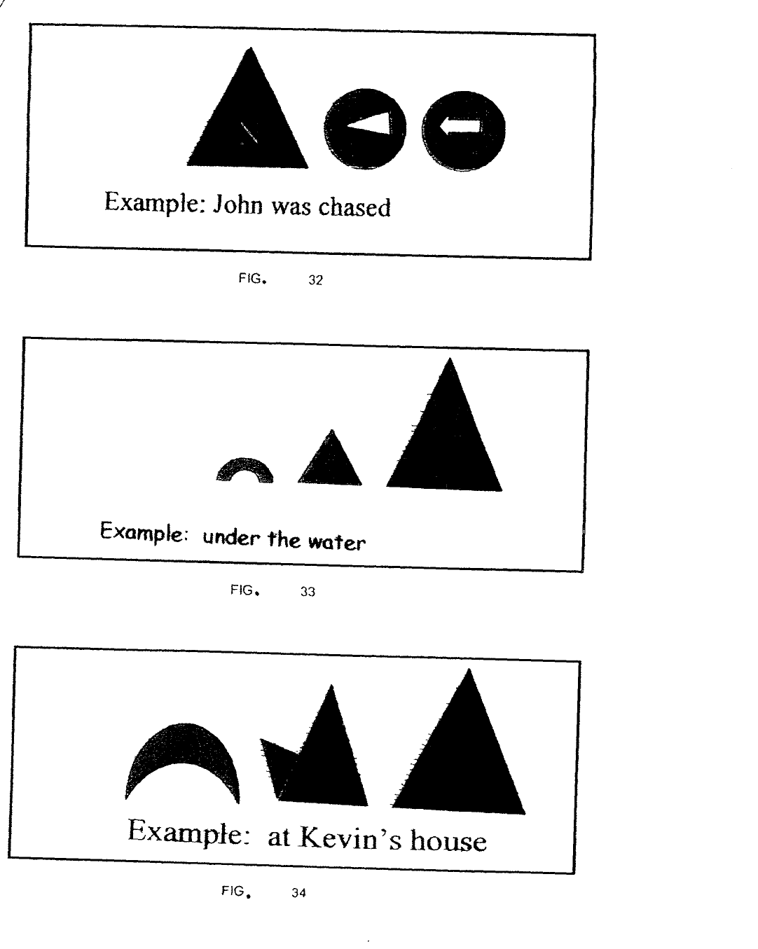

The timeline is very useful for more complicated verb structures, like the past perfect tense. For example, enact another simple play, illustrated by FIG. 44.

Rosa entered the room She had finished her homework. She gave the homework to the teacher and sat down.

The question marks imply that the time the homework was finished is unknown. Compare this to another version of this story, illustrated in FIG. 45.

Carlos entered the room. He finished his homework. He gave the homework to the teacher, and sat down.

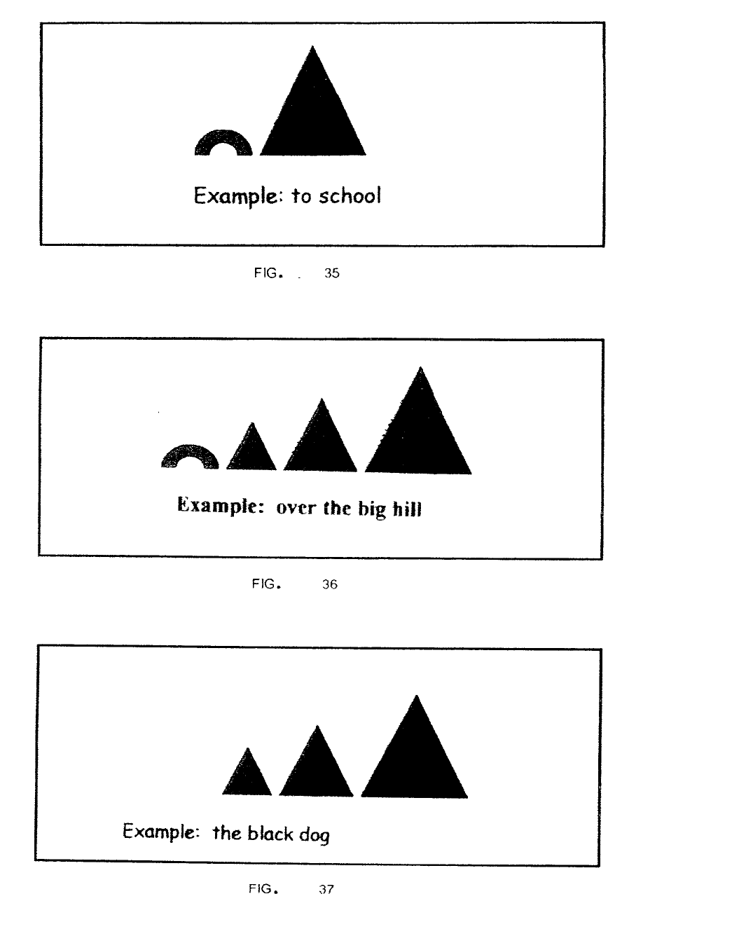

What a difference to the meaning of those two stories the single word bad makes! But the placement of the two red circles to the left of the timeline, showing bad finished, is a very clear and strong image, and is most helpful to students in their understanding of the concept. Similarly past progressive perfect can be shown, as illustrated in FIG. 46.

Conor stamped his foot. He had been looking for his keys all day.

The Passive Voice

A useful alignment of two arrows helps to introduce the passive voice. Starting with the concept in its most common use, the past tense, we notice how the two arrows line up (see FIG. 47).

Both arrows point to the subject. You could say that the ‘action’ is coming from the right, towards the subject. And that is right: the subject in the passive voice is doing nothing. Students should notice this combination of the verb BE next to a past tense verb as being unusual, breaking a rule they have learned earlier. Obviously it is wise to introduce the passive voice only after the active voice has been well understood. This alignment of the arrows occurs only in the past tense. But as an introduction to the passive voice it can be a useful way to visualize the concept.

Future Tense

For future tenses, students should learn that the red circle representing the future tense and the future for BE symbolize two words, illustrated in FIG. 48. One good exercise is to model one verb structure, using the two-dimensional or three-dimensional shapes, and for students to write the correct form.

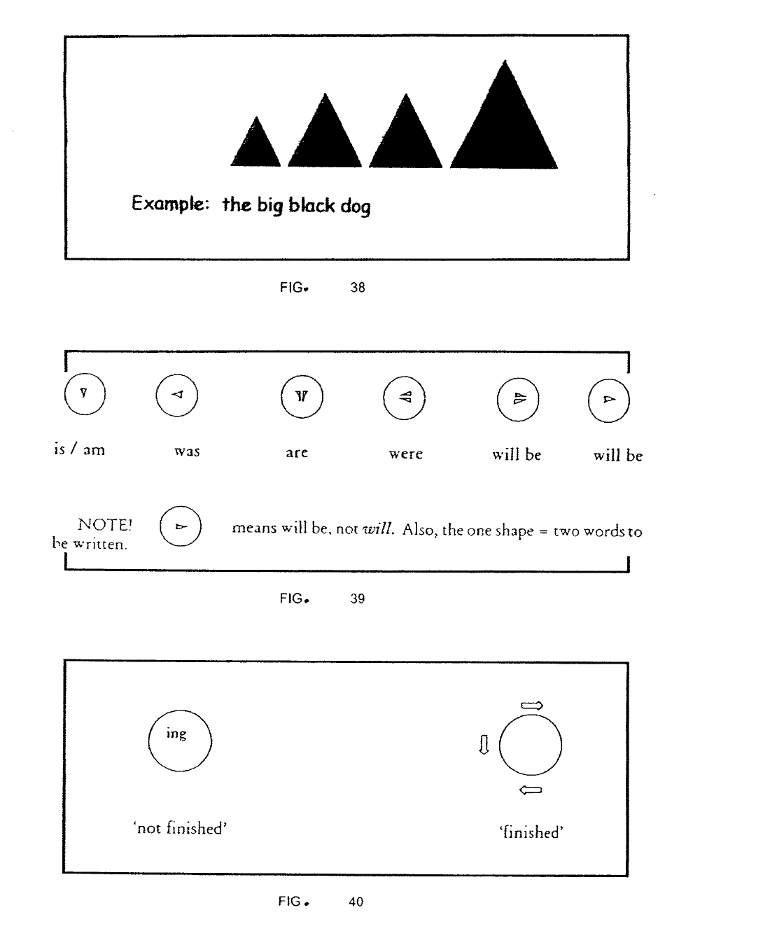

For example, you can set up the future tense symbol, and ask the students to write walk in that tense—see FIG. 49. Then set up the future progressive, as in FIG. 50. Again ask the students to write walk in that tense. This can be done with all the verb tenses you cover. It is obviously important that students understand the concepts behind each tense, but it is also important that students recognize the correct written forms too.

The Blank Red Circle

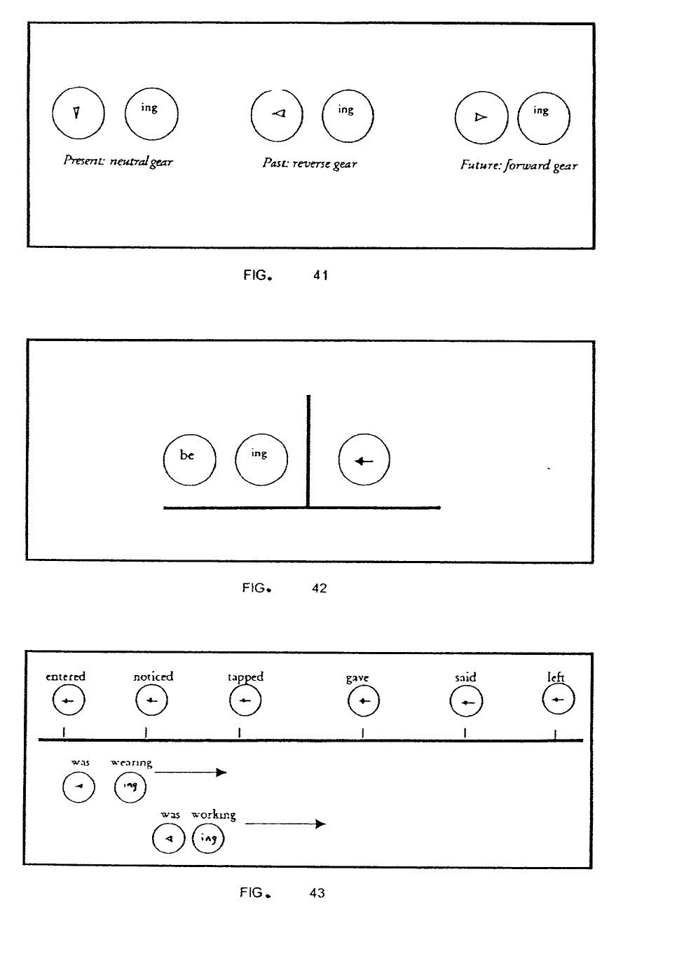

A blank red circle is useful to show that some verbs are left ‘unchanged’, if preceded by auxiliary verbs such as should, can, could, must, ought, must, illustrated in FIG. 51.

Into this circle go unchanged words without -ed or -ing, like stay, sleep, leave, work, rest, cook.

More Advanced Tenses

The present invention is designed to develop understanding of the basic levels of English grammar. Young deaf students face an incredible challenge in trying to learn the rules of the English language. The present invention is designed to give these students a hand up on to the ladder. If the structures we have discussed in this paper have been thoroughly understood by the students, then they should be on the ladder and able to continue the climb upwards. At this point they should have less need for this kind of approach.

But we can still use the present invention for visual demonstrations of more complicated structures. At this stage students will be very familiar with the timeline. Tenses like the past perfect progressive, the future progressive, and the future perfect progressive can be dealt with using the method they know.

Some examples:

Future perfect, illustrated in FIG. 52.

Tomorrow I will go to the post office. My parcel will have arrived.

Future Progressive, illustrated in FIG. 53.

I will see my teacher later. She will be preparing my test.

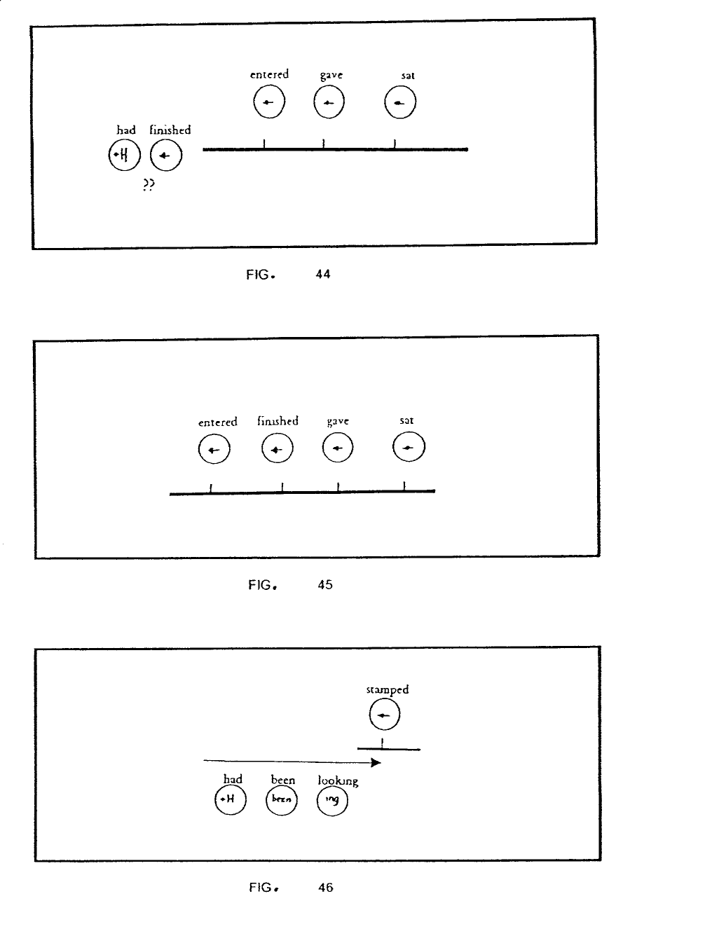

Future Perfect Progressive, illustrated in FIG. 54.

Sally will help Jordan. He will have been working on the roof

Present perfect has finished, and present perfect progressive has been laughing can also be indicated with the timeline/drama activity. These structures might appear in dialog:

Hello Peter, what are you doing?

Hi! I have been typing for an hour. I have typed up my journal.

Not

The small black circle stands for not. It comes after the first verb.

James was working (see FIG. 55)

becomes

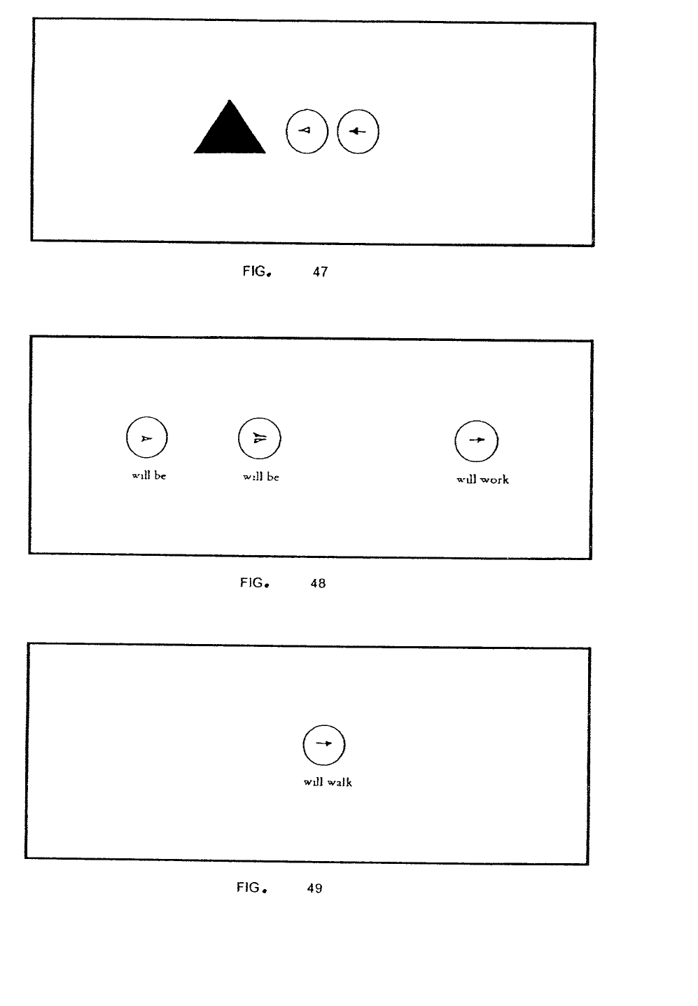

James was not working (see FIG. 56)

Sally jumped. (see FIG. 57)

becomes

Sally did not jump. (see FIG. 58)

Note here that the past tense arrow shifts from the action verb to the auxiliary verb did, and the second circle is a ‘blank’. Students will need to practice this form.

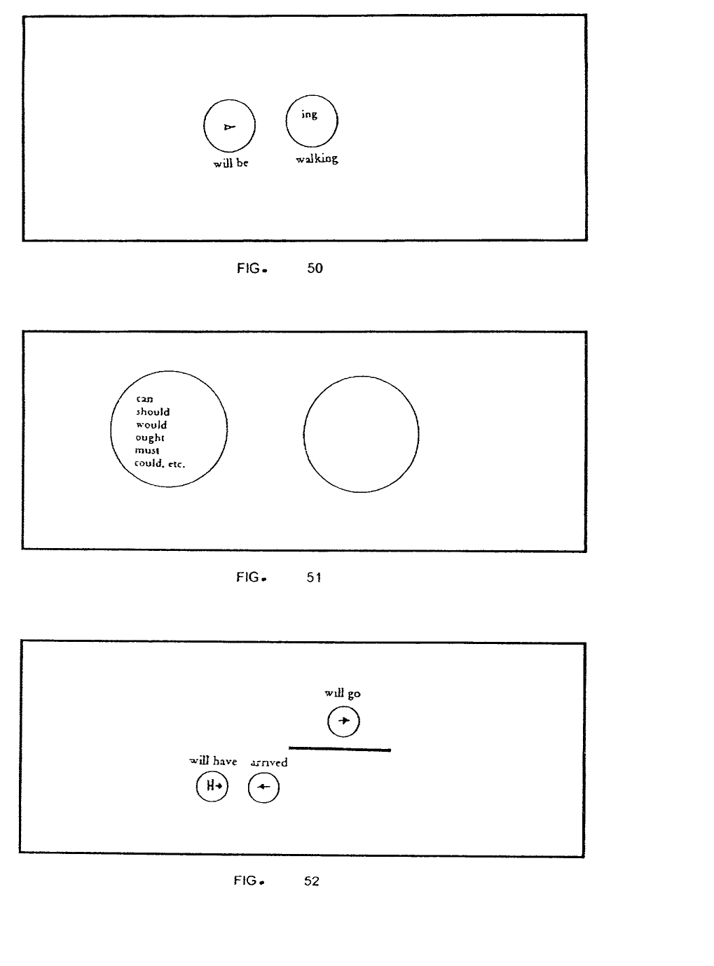

Muhammad had finished. (see FIG. 59)

becomes

Muhammad had not finished. (see FIG. 60)

To conclude, these suggestions and ideas are some examples of the way the present invention can be used for teaching students to analyze, and visualize verbs, and so develop an understanding of verbs on a conceptual level. With this understanding, students should write and read with more confidence. We believe it is important to build this understanding carefully, ensuring that the students grasp the ideas at each stage. Try and get the students to think about the purpose behind the present invention. With all the shapes, but especially verbs, each student should be thinking on different levels:

1. What does the present invention symbol mean?

2. What does it look like in print?

3. When and how do I apply it in my own writing?

The present invention, being a tactile and visual resource, obviously lends itself to a great number of lively and enjoyable teaching options that will engage students in such a difficult area. Doubtless the creative teacher will think of many more activities we have not yet thought of. Let us know when you do. In the meantime, have fun.

### EXAMPLE 3

### The Early Stages

The present invention is a powerful tool for showing the basic structures of English language with very young children. Rules of grammar can be shown without being named, even before words are introduced. This would allow the complicated structures to be developed at a conceptual level, before they are presented in the written form. At the beginning of the grammatical learning processes, the parts of grammar, such as nouns, verbs, adjectives can be seen and demonstrated through some wonderful games and activities, before a single word has been written. This allows the concepts to develop freely, in a refreshing way.

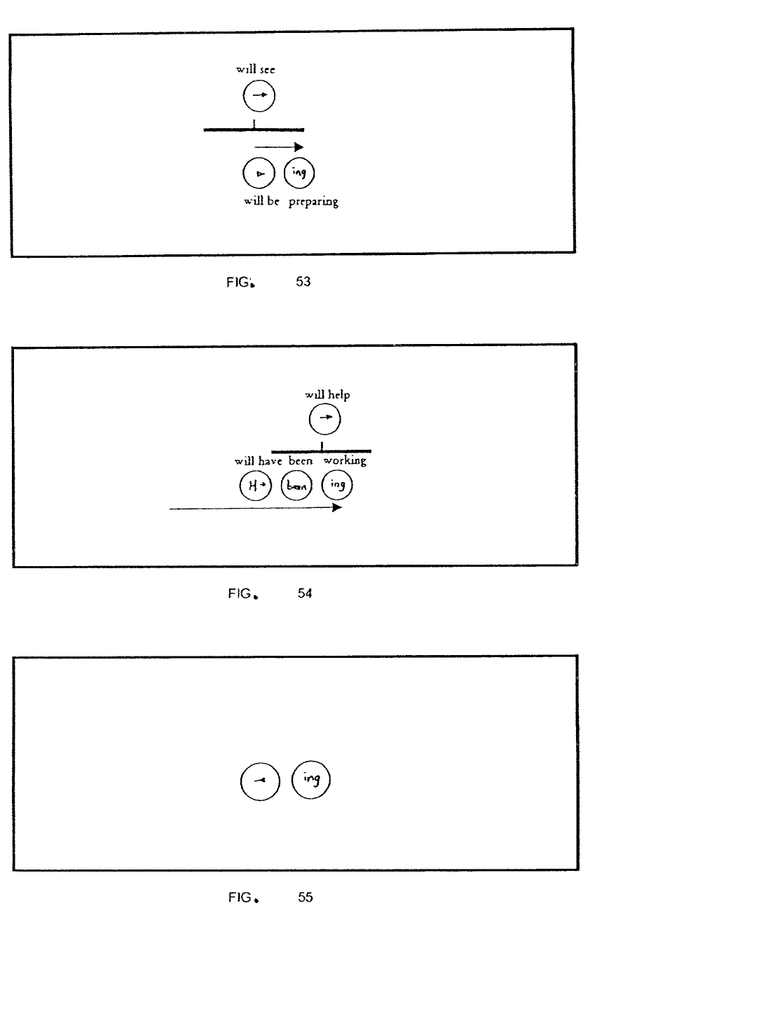

Perhaps the simplest place to start with the present invention is with nouns: the room you are teaching in is full of them. The present invention has three categories of noun, although the blank black triangle can stand for any of them. One activity would be to get the students to identify things in the room. This could be modeled by the teacher. Pick a pencil, a book, a cup, a ruler, or a camera. Bring in some interesting objects from home, and put them in a box or an area clearly identified by the T black triangle. But remember to put the small light blue triangle by the T triangle, as illustrated in FIG. 61.

There is no need to draw special attention to the light blue triangle. Make up a story, and say that this light blue triangle is inseparable from the T triangle. Let the students see that even though you never draw any attention to it, it is always there. Make a book dedicated to this one simple structure, and get children to draw pictures or cut magazine pictures and put them in this book. Another book can be made for the N triangle, with pictures of family and friends. The N triangle stands alone.

When you introduce simple prepositional phrases, again it is best to concentrate your attention on the elements that are easiest to understand. This would be the noun—cup, book, pencil, elephant—and the preposition—in, on, under. You could play games with objects, and get students to express in American Sign Language what the green crescent shape stands for, and what the T triangle stands for. Then model the present invention shapes in the right order, as illustrated in FIG. 62.

Once again there is no need to draw attention to the small light blue triangle. And you could work on this structure before you introduce the English written version of this structure. Again, make a book with the child dedicated to this structure.

### EXAMPLE 4

### Introducing the Verb to be

The verb to be presents two particular difficulties for children learning English. The first difficulty is one of meaning. Look at a definition of the verb BE in your dictionary: it is a word that is hopelessly difficult to define. The second difficulty is the fact that this verb has many tricky disguises. Is, am, are, was, were, will be, been, and being all stem from one word BE.

These complications have to be overcome. And for the youngest students, developing grammatical concepts at the ‘preword’ stage, the present invention is an excellent tool. With the present invention we simply bypass these problems. Hearing children never stop to analyze the meaning of BE, nor do adults offer any definition. BE is just always there, in nearly every sentence. We can do the same thing.

When we start with simple prepositional sentences—Kevin is under the table, the books are on the chair, the camera is in the box—once again attention is on the tangible elements in those sentences—Kevin, under, table—books, on, chair—camera, in, box—and once again we have the article, and now the BE red circle ever present. At this early stage there is no need to show the word forms, if you feel it will be overwhelming for the child. Model the sentence in the two-dimensional and three-dimensional shapes, and then play games with objects around the room. For example, set up a camera on a table, and model the sentence illustrated in FIG. 63. Start with is now, and stay with it. After a while work with is and are. Later on, introduce the element of tense. Set up the camera and the table again, as in the structure above. Then invite the students to shut their eyes, remove the camera and change the red circle as illustrated in FIG. 64.

When using adjectival phrases—Marty is happy, Jean and Simone are hungry, the dog is thin—the same ideas apply. The teacher can set up fun activities. The students can act, or you can use pictures and drawings. Concentrate on the obvious elements—Mary, happy, Jean and Simone, hungry, dog, thin—and model the correct BE circle each time.

Let the students see you make the changes to the BE circle, but there is no need to pause and explain anything about that circle's meaning, other than ‘It just has to be here.’ This is a very important stage, yet the concepts can be developed with all kinds of enjoyable activities. The symbols for is, are, was, were even will be can be practiced over and over in these simple structures. The students will gradually get used to seeing the red BE every time. After a while they should notice if you deliberately leave it out. Then they should develop an intuitive knowledge of the purpose of BE. One way to check on this would be to set up the wrong BE shape, (2 arrows instead of 1), or to have the right arrows facing the wrong way (wrong tense.) This would be very significant. In fact don't proceed until these concepts have been understood.

Introduce have and has in much the same way. Susanna has a blue bike, the policewoman has a new car, I have brown eyes.

Action Verbs

The first verb tenses we recommend for young students are: progressive present and past, and simple past as discussed above. Children love drama, both watching and acting themselves, and with the present invention we make use of that enthusiasm. It is possible to introduce the concepts behind these verb tenses before children see them in print. Once again teachers should use their own judgment, but it might help to develop the concepts before expecting children to recognize them in print.

One idea would be to have a little puppet theater. Open the curtains, and they see someone drop a cup. Close the curtains. Set up the present invention shape illustrated in FIG. 65. There is no need to write anything yet, just develop the concept behind a finished action verb.

Now a different play! Open curtains. Someone is painting, and continues to paint until the curtains shut. Set up the present invention shape illustrated in FIG. 66. BE must be next to the -ing circle: give the students a story about how they get terribly upset if they are alone, or separated. Obviously more complicated verb tenses will be developed later, through other activities, and after the students have begun to read.

The Sentence Map

The present invention map is designed to let students see how a simple sentence is constructed. It was necessary to keep the map simple: and that has meant certain things are not included. A true map that showed all the permutations possible even in simple sentence structure would have simply too many ‘options’ and symbols. This map is intended for the students who are beginning to write, and seeks to help them construct simple, clear sentences. Knowledge of the present invention symbols is obviously essential before students use the map. Students can trace a line from left to right, picking out the symbols along the way, and then write a sentence from those symbols.

There are loops in the sentence map, which indicate optional routes, but notice: there is no way you can avoid the first verb! It is important also to remember that the one red circle can still mean two or three words to be written, (was working, has been sleeping). The loops are for both prepositions, the adjective after the verb, and each adverb. For the adjective after the verb, the road has a fork, indicating that you could end on the adjective (Mary is tired), or go back up and continue along the map. (John is upset with you.) Also notice that it is impossible to follow this map and make mistakes like the Michael, me told she, he car, under table, etc.

There is only one conjunction on the map itself. Conjunctions like and, so, but, because, etc., could appear in several places along the ‘road’. If we placed them all on the map, in all the places they could possibly appear, then it would diminish the clarity of the map. We suggest using a ‘mobile’ conjunction, which can be placed by the teacher or student in the right place. Using the conjunction will often send you back to the start of the map—Martins came to Vienna because Lime offered him a Job—but not always. Sometimes it takes you back one place—I am cold and tired. Sometimes you go back a couple of places—They opened the door, and saw the mess. However, I have allowed myself to use conjunctions, and wrote this piece, following the map:

Yesterday, I drove to Leeds. It is a long drive. My wife followed in her car. We always bring our car to Leeds. Alan is our mechanic. He is a very nice man. We trust him with our cars. His garage is in the woods. It is an old barn. It was very cold inside the barn, but Alan is used to it.

Alan has at least 400 old Volvos in the woods. He uses these old cars for his spare parts. He works with a wonderful woman. Her name is Lee, but her friends call her ‘Volvo Girl.’ She is a great mechanic. She loves to talk about cars, and she knows a lot about them.

Alan and Lee opened the bonnet, and looked at the engine. They soon saw the problem, and fixed it. We were surprised at the bill. It was very reasonable. It always is. We thanked Alan and Lee, shook their hands, and drove to our town.

### EXAMPLE 5

### Sample Lessons

Introduction

The following 20 lessons are suggested steps for a teacher or parent to follow when using the materials of the present invention. The lessons have been designed to follow a basic grammatical progression, with each lesson building on the grammatical concepts learned in previous lessons. Each lesson and the activities will be a springboard for other ideas: from working with children you will see their needs and you should see from these lessons that you can be very creative and flexible with the materials of the present invention.

The lessons are illustrated by maps, which identifies the targeted grammar skills. These lessons show how teaching can be designed around basic grammatical concepts. The maps are read from left to right. The maps may be sketched onto a magnetic whiteboard, and the two-dimensional shapes may be added along the way. Paper may also be used.

FIG. 67 shows MAP 1. Any time in the lessons you see a fork or loop on the map, it means we have reached a point where we need to analyze and think about the meaning of the sentence that we are trying to write. The fork at the start of this MAP 1 is at the point when we are thinking about using, for example, either “Ron” or “The man”. This is one of the targets of the lesson. At a fork, you have to make a choice: it is one or the other. “The Ron” is not possible.

At the fork on the road, we are asking the students to think about their choice, to discuss their decision, and then to implement the decision by moving the shapes, writing an appropriate sentence, or by reading. We also have a ‘loop’ for the blue triangle, the adjective. Loops indicate an option: you can take the option or continue on a straight line to the end. In some lessons you will need to use the option to make your meaning clear.

Note also on this map, that right after the red circles, the verbs, there is an option to stop. This is for simple subject—verb sentences, like “Jamie jumped.” or “Beth sneezed.”

Designing your own map is fun. Draw a map yourself and the two-dimensional or three-dimensional shapes. It is easy and soon you will want to design your own. That is the point! These lessons are suggestions, but you may well want to design your own maps, produce your own forks and loops to get the grammatical targets you have identified from working with the students.

This approach offers enormous flexibility. It is a wonderful way to design a convenient, meaningful lesson in moments. When you read with students, or analyze their writing, you will probably see areas in their knowledge of grammar that need strengthening. This ‘mapping’ approach enables you to ‘grab the moment’, design a map of your own, and then work with it in enjoyable, creative ways, and thereby have a real impact. It is fun and rewarding.

Lesson 1 is all yours to design!

Lesson 1

Purpose of Lesson 1

To introduce the black N triangle for name, illustrated in FIG. 68. This is a good place to start, as young children can easily identify with the names of all the people they know.

Activities

Find pictures of family, friends, peers, and even pets that the child knows. Find some colored paper and make a book. The front cover can have the black N triangle for name preferred in the present invention. Then cut pictures and paste them into the book. Use old magazines, like People; and find names of people on the pages. Cut out the pictures and paste into a different book. Have a big, bold black N triangle, as pictured in FIG. 68, as the cover.

Look for all the names in your reading book.

Lesson 2

Purpose of Lesson 2

To introduce the T triangle for thing, illustrated in FIG. 69. This can mean any object, but also people and animals that we can not give a proper name to. This is dealt with more fully in the next lesson.

Note: The light blue triangle should always be with T triangle in the early stages. There is no need to label this shape, or draw too much attention to it, just let the child know and see that it always is attached to the T triangle.

Activities

It's nice to make up stories for the shapes. Here is the outline of a story about the little blue triangle who wanted a friend:

“She approached the N triangle first, but N had no time for her, and sent her away.—She told her sad story to the T triangle, who was only too delighted to have a friend. Now the two of them are inseparable friends. And N with his big ego still likes to be left alone.”

Feel free to use the shapes as ‘puppets’ and really embellish this story!

In the previous lesson we suggested making a book. This is a nice activity for young children. Fold about 6 to 8 pages, and past the shapes to the cover. You can make smaller shapes for each page. Now go through magazines and catalogues and cut out pictures.

Reading: find matches for these symbols of the present invention in the books you read.

Lesson 3

Purpose of Lesson 3

To get students to think about when to use these two forms, and to reinforce the fact that the T triangle can mean a person. Also they can be introduced to the left to right ‘road map’, illustrated in FIG. 70, so they can see how they will be asked to make choices in most subsequent lessons using the present invention.

Activities

1. Use either the two-dimensional or three-dimensional shapes. Set them up to show that a choice has to be made between these two forms. Mix up pictures of people the child knows, and people the child does not know. Turn each picture over. Talk about the picture, and then put the picture with the correct shape.

“Who is this? Mummy.

Who is this? Sally.

Who is this? Boy.”

Sally and Mummy go with the ‘N’ triangle. ‘Boy’ goes with the ‘T’ triangle.

2. Get the child to shut his/her eyes. Put the light blue triangle with the N triangle. Let the child figure out what is wrong. Or put the N triangle with the T triangle. In other words, make deliberate mistakes. Kids love to correct you!

3. Make a book again—see lessons 1 and 2—with both of these options available.

4. Reading/writing: make lists, classifying things and people into these two groups. Under the shapes, print or write labels.

Find matches for these shapes in the books you read.

Lesson 4

Purpose of Lesson 4

Introduce ‘is’, introduce first sentence structure, introduce adjectives.

Activities

1. Set up the structure illustrated in FIG. 71 with the two-dimensional or three-dimensional shapes. Play a simple game where one person shuts his/her eyes, and the other person mixes up the shapes. Then open your eyes and put them in the right order.

2. Acting games. Take turns being happy, sad, angry, excited, etc. feelings are fun to play out. If you have a camera, you can take pictures showing the feelings. Make another book, devoted just to this one structure. Or you can use magazine pictures and make books from that.

Sample Sentences

“Jane is happy. Sally is sad. Felix is angry. Mark is tall.”

Question

The structure illustrated in FIG. 72 gives us a chance to introduce a full question, who.

Who is sad? Who is tall?

Lesson 5

Purpose of Lesson 5

This lesson introduces the P triangle, and the green crescent shape, for prepositions, illustrated in FIG. 73. If you have not done lesson 4, this is the next logical place to introduce the “is” shape.

Activities

Take a simple object, like a toy car. Establish that this car is represented by the T triangle. Place the car in a boot. Identify the boot as the P triangle. Set up all the shapes in the right sequence. Lead with questions.

“Where is the key?

Is it on the boot?

Under the boot?

In the boot?”

With the correct answer, identify the green crescent, which in this setting means in. Now keep the original objects, but change the position, to on or under or behind. Make no special mention of the red circle as you pass it in the sentence, although you should sometimes let the students see you emphasis that the arrow is pointing down.

Use other objects around the room.

Mix up the shapes, placing them in the wrong sequence. Let the students arrange the shapes correctly. Be very specific about the red circle, the arrow must always point down.

Sample Sentences

“The key is on the shelf. The boat is on the water. The fish is in the boot.

The pencil is on the book. The car is behind the box.”

Variant

You could substitute the N triangle for the light blue and T triangle. We have made small pictures of students and teachers—faces only, and pasted them onto small film container caps. Then we put the ‘person’ on the book, in a sock, or under a shoe. We only use the faces, so there can be no dispute about these people doing things like running, swimming, or walking. We are saving action verbs for later.

Sample Sentences

“Alicia is under the boot. Marty is in the sock. Freida is in the box.”

Questions, Referring to FIG. 74

Where is the cup? Where is the key? Where is the book?

Lesson 6

Purpose of Lesson 6

To develop an understanding of the use of is and are. Reinforce prepositional phrase. For young children you could just work on these patterns and concepts without words.

Activities

Set up the two-dimensional or three-dimensional shapes in the pattern illustrated in FIG. 75.

1. Find some objects around the house or classroom. For the P triangle, perhaps use a couple of things like a box, cup or boot. Use other objects, like a pencil, spoon, toy animals, keys, etc. Now place a key under the boot. Show the child the correct verb, with the single arrow pointing down. Trace the ‘sentence’ left to right. Now put some pencils in the boot. Trace this new sentence; this time you select the verb with two arrows pointing down. Discuss with the child your reasons for this choice, that the two arrows are for two or more objects, and the arrows point down because it is ‘now’.

2. Hide and seek. Have sets of objects, some which are single and others in sets of two and up. Place a single object under the box, while the child is not looking. Trace the correct sentence, and let the child guess the right object under the box. Now put one of the multiple objects (like keys) in the box. Trace the correct sentence for this set-up.

3. Set up the objects—the cow is behind the shoe—and mix up the shapes, allowing the child to reassemble them correctly.

Sample Sentences

The cow is on the book. The pencils are in the shoe. The keys are behind the boot. The boys are by the table.

Reading

In the books you read with the child, point out this structure as it occurs. Type out sentences from some of the activities you have done with this structure.

Question, Referring to FIG. 76

Where is the key? Where are the cows?

Activity

Use the same objects as used in the activities above, and take turns asking each other these questions.

Lesson 7

Purpose of Lesson 7

To show how and when to use is or was, illustrated in FIG. 77. Once again, this can all be done before using words. Develop these essential concepts first!

Activities

Use two-dimensional or three-dimensional shapes.

1. Hide and seek. Use objects in the way you did for lesson 6, except now they are all single objects. Set up the objects in the same way. For example, show a key on a box.

Sentence: The key is on the box.

Now ask the child to shut her/his eyes. Remove the key completely! A pocket is a good place. Ask the child to look. The key is gone. After the child has looked all around the box, and is satisfied that the key is gone, ask her/him about the key. Did you see the key? Did you see it here, on the box? It was really right here? You saw it? Now point to your ‘sentence’. Look concerned. Something is wrong. The arrow on the red circle is pointing down, and that means ‘now’. But the key is not here! Turn the verb circle, so the arrow is pointing left. Discuss your reason carefully. Do this with other objects. Take turns, and let the child set up the sentence and objects.

2. Set up the objects, then mix up the shapes, making deliberate mistakes. Allow the child to put them in the right order, with particular attention to the arrow on the red circle.

Sample Sentences

The key is in the boot. The key was in the boot. The cow is under the chair. The cow was under the chair.

Question, Illustrated in FIG. 78

What is under the table? What was under the table? What is in the box? What was in the box?

Variant I, Illustrated in FIG. 79

This is fun. Use the ‘heads only’ pictures you used in lesson 5, and do the same kind of thing. This will give you funny sentences like Mom is in the sock. Mom was in the sock. Dad is under the book. Dad was under the book.

Variant II, Illustrated in FIG. 80

This variant is a little more complicated, as far as the meaning behind is and was is concerned. This structure enable you to continue to develop understanding of is and was.

Activities

1. You could enact feelings, like happy and sad. Maybe have someone behind a little curtain. The curtain opens and you see a sad face.

Sentence: Ron is sad. Curtain closes, then opens and Ron is not sad now.

Sentence: Ron was sad.

But don't be surprised, if instead of Ron was sad, you get Ron is happy. You need to talk carefully with the child about this one.

Yes he is happy. But did you see the sad face? Was he happy before? No? What was he? Sad? Right, sad. So what do we do with this red circle?

2. Use pictures of the child when he/she was smaller, even use baby pictures, or use old pictures of people the child knows. Compare then and now pictures.

I am tall. I was little. I was weak. I am strong. Uncle Jim is chubby. Uncle Jim was thin. (Check with Uncle Jim first.)

Lesson 8

Purpose of Lesson 8

This lesson helps to develop understanding of are and were, illustrated in FIG. 81.

Activities

Very similar to lesson 7, except that now the objects in the shoe, on the box, under the table, are in groups of two or more.

Sample Sentences

The books are under the table. The books were under the table. The keys are in the boot. The keys were in the boot. The fish is in the water. The fish was in the water.

Questions, Referring to FIG. 82

Where are the keys? Where were the keys? Where are the books? Where were the books?

Variant, Illustrated in FIG. 83

Sample sentences: The cups are dirty. The cups were dirty. The boots are new. The boots were new.

Lesson 9

Purpose of Lesson 9

Introduce has as a verb in a sentence without action. Has is used for one person or thing. The exceptions to this rule are with the pronouns/and you. There is a loop here for the adjective: you can decide if you want to include it or not. Refer to FIG. 84

Activities

You can talk about people or objects in the room, or use pictures from a magazine and make a book. Start with a theme, like pets, bikes or cars. Once you do a survey of bikes, for example, you could end up with sentences like:

Terry has a blue bike. Mark has a yellow bike. Jen has a black bike. Stan has a green bike.

NOTE. You might get into a discussion about the word a here: why aren't you using ‘the’? You can postpone this discussion and continue to use the. The use of a, in this context, sounds right in English, but it may be hard to explain to students that it is a better word than the. The differences between a, the, some can be dealt with later as a specific topic. At this stage we just want to impress upon the students the ever-present need for a determiner, represented by the light blue triangle.

Variant I, Referring to FIG. 85

This structure uses an adjective as the determiner, instead of words like the, a, some, etc. It seems also that this structure applies to plural items. You can say Jane has new shoes, or Jane has worn new shoes, but not Jane has new car! So think carefully about which things you will describe. Perhaps start with hair, eyes, shoes, fingers.

Sample Sentences

The boy has blue eyes. Mummy has long hair. June has black shoes. The table has four legs. The cat has long whiskers.

Variant 2, Referring to FIG. 86

Use pronoun/with have. This is an exception to the rule that we use have with more than one person. This is a good time to introduce and practice this exception.

Questions, Referring to FIG. 87

Who has the blue bike? Who has the big book? Who has the key?

Lesson 10

Purpose of Lesson 10

This time we introduce have as the verb in a sentence without any actions. This lesson is very similar to lesson 9, and can include the same kind of activities. Have is used when the subject of the sentence is more than one thing or person.

We have made 2 ‘loops’ on the map, illustrated in FIG. 88. You can simplify this if you like, if you intend to do one structure at a time. The map above makes it possible to have a variety of sentences like:

The policemen have fast cars. The boys have short hair. The cats have long tails. The sharks have sharp teeth. The girls have the new computer.

Variant I, Referring to FIG. 89

Like lesson 9, but now you can pair students who have things in common:

Sarah and Trey have blue eyes. Andy and Jack have short hair. Alice and Rosa have red shoes.

Variant 2

Use the pronouns they and we, illustrated in FIG. 90. You can follow on from the previous activities.

They have fast cars. They have short hair.

Sarah and Trey could write a book about things they have in common.

We have green eyes. We have black shoes.

Questions, Referring to FIG. 91

Who has green eyes? Who has red shoes? Who has the key?

Lesson 11

Purpose of Lesson 11

To introduce the first action verbs, starting with the simple past tense, illustrated in FIG. 92.

Activities

Use one or two objects in the room, like a small cardboard box, paper cup or an old shoe, and then ask the student to do something with it, like kick, drop, push, throw, catch, squash, etc. Young children love action, and this is a fun activity. Stop to talk about the arrow in the red circle: it is very important. Be sure that the arrow points left, and let the student know that we use this to show that an action is finished. Play the game of mixing up the shapes, and turn the arrow the wrong way: let the students ‘fix’ the shapes. Then they can do the same for you, and you fix them.

Sample Sentences

Jane kicked the box. Alan squashed the cup. Helen threw the shoe.

Question, Referring to FIG. 93

Who threw the cup? Who dropped the book? Who caught the hall?

Reading

With the simple storybooks you are reading, identify the action verbs. Make a list of all the action verbs on a page or the whole book. Here is what you would find from The Wind Blew, by Pat Hutchins. (Refer to FIG. 94)

blew

took

turned

snatched

swept

whipped

kept

grabbed

tossed

plucked

lifted

whirled

blew

pulled

tossed

mixed

threw

blew

Look at a brief video clip, a minute will be enough. Count all the completed actions you saw.

Lesson 12

Purpose of Lesson 12

To show the function and place for adjectives in describing objects, as illustrated in FIG. 95.

Activity

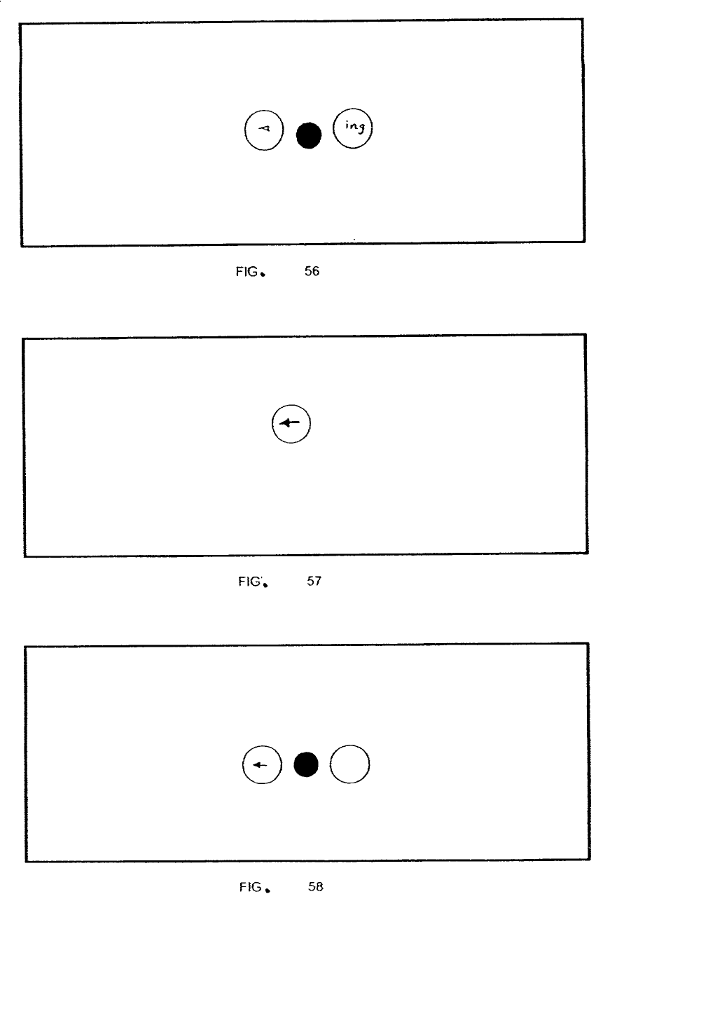

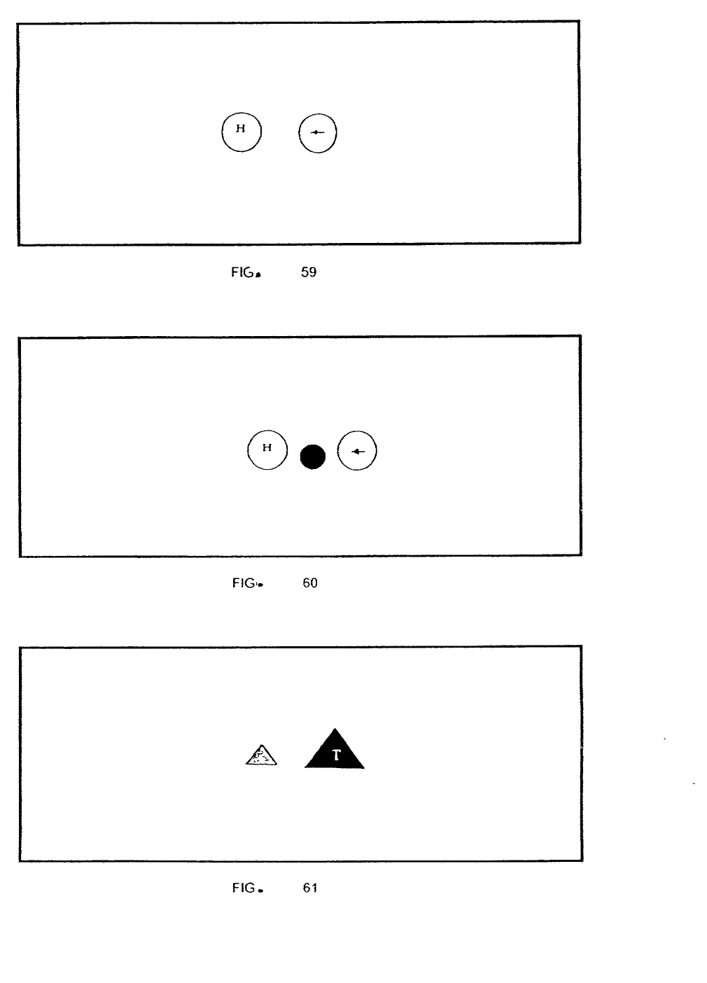

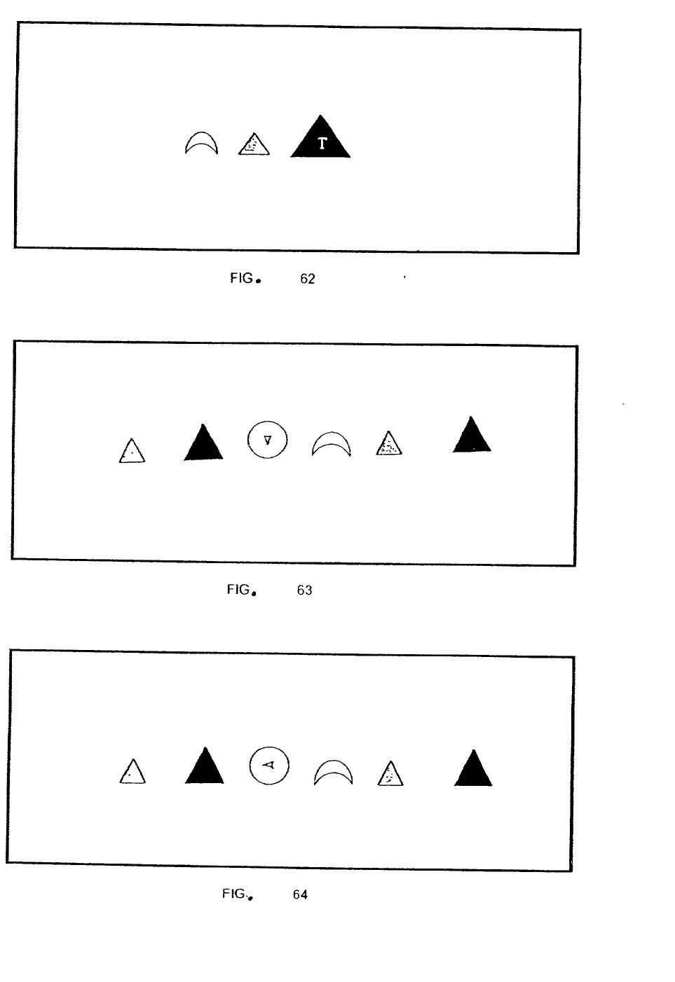

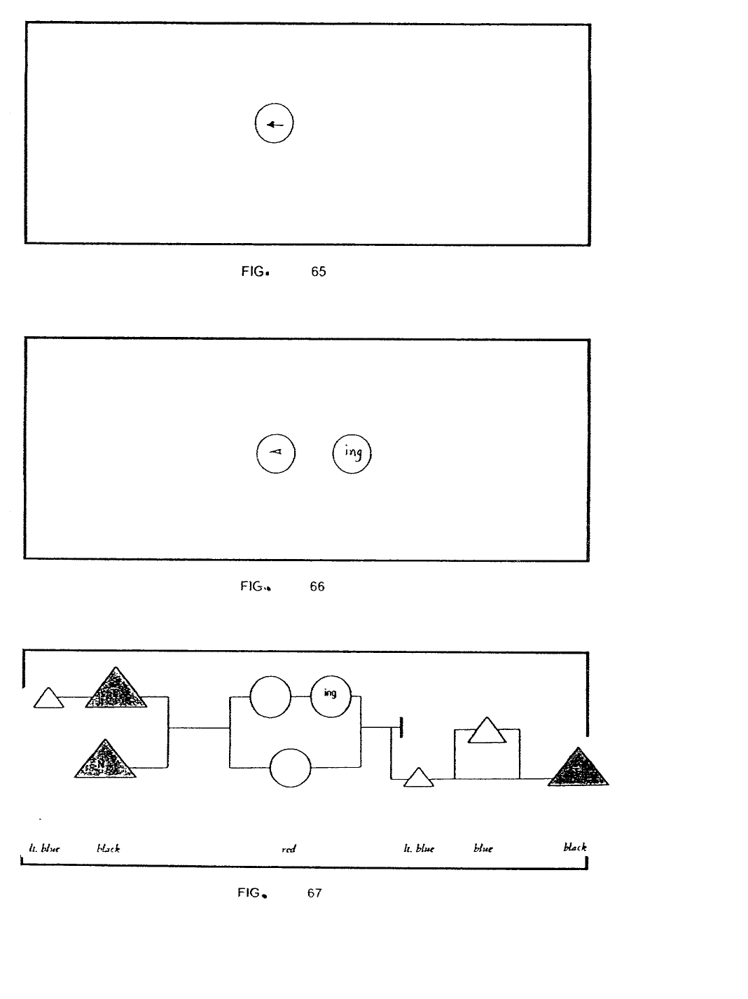

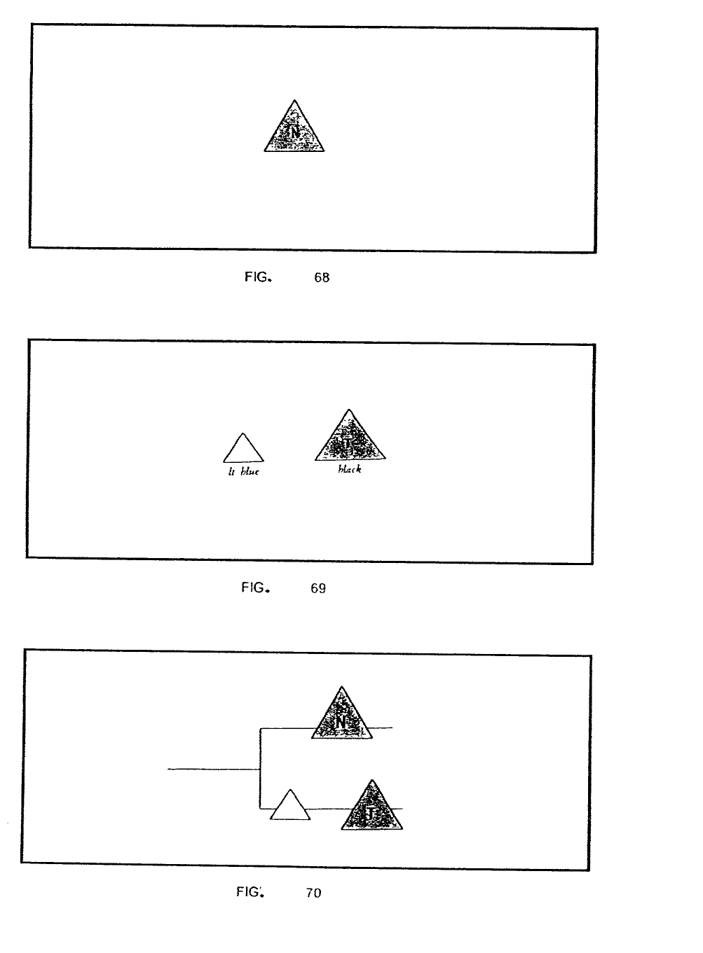

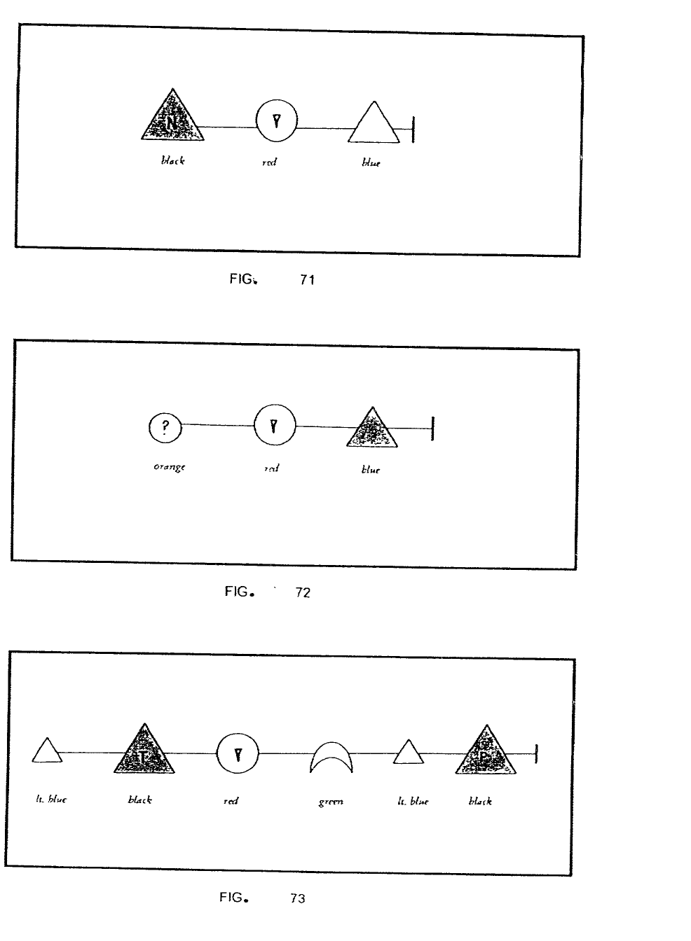

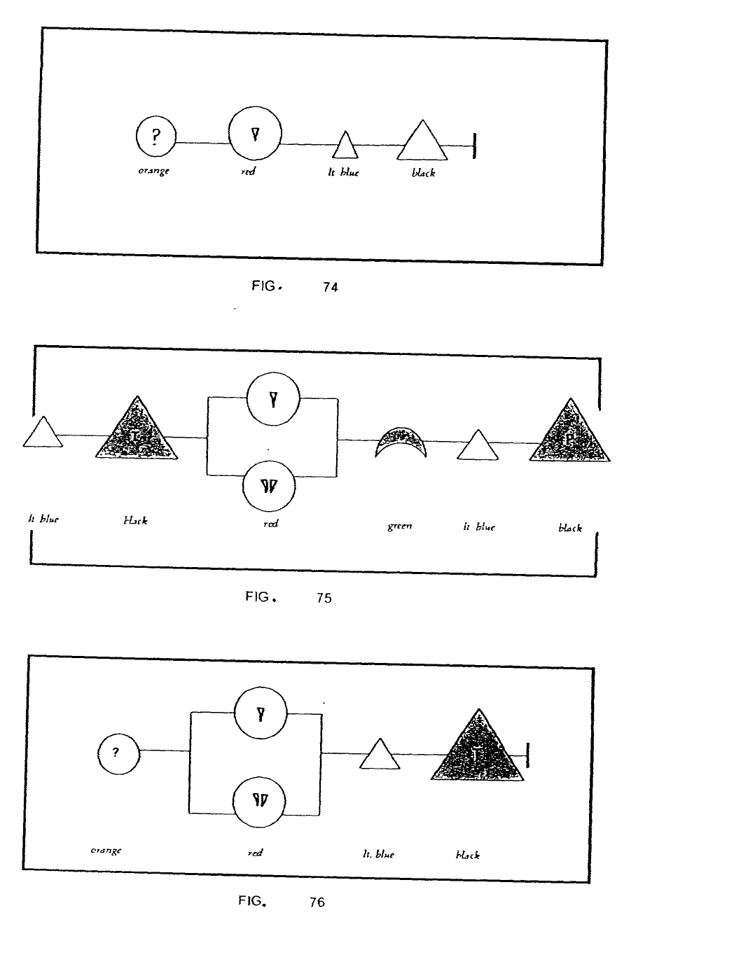

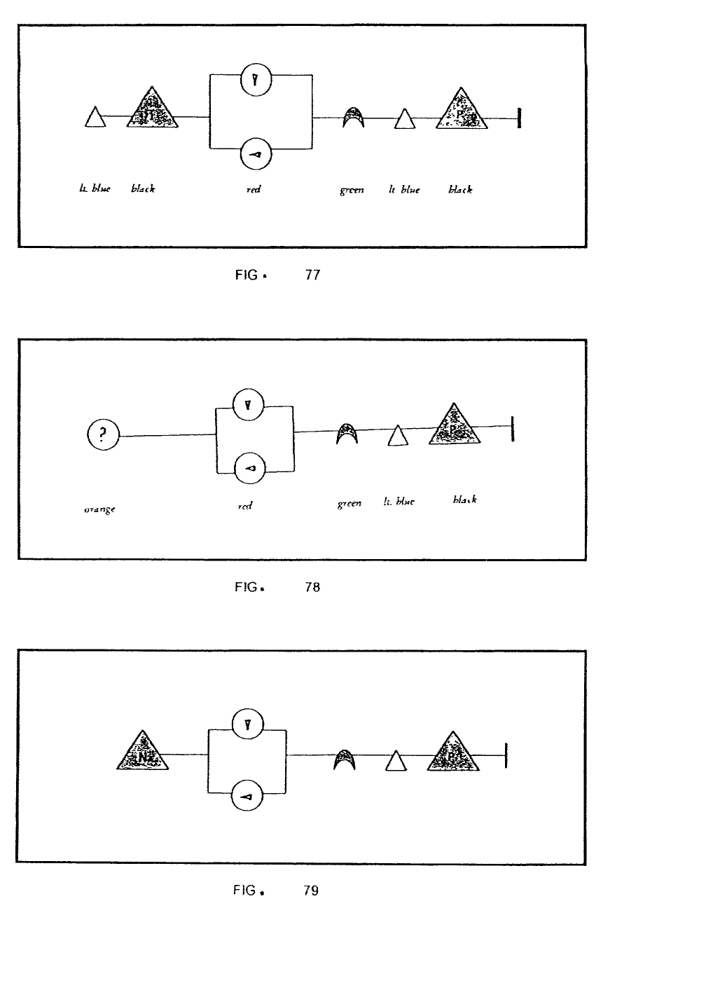

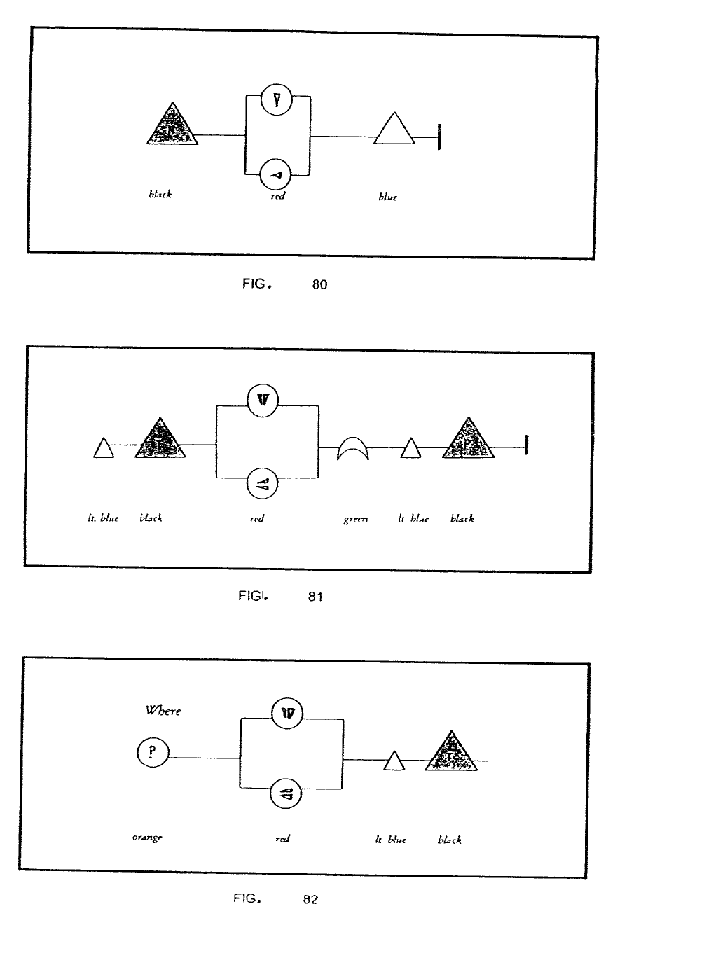

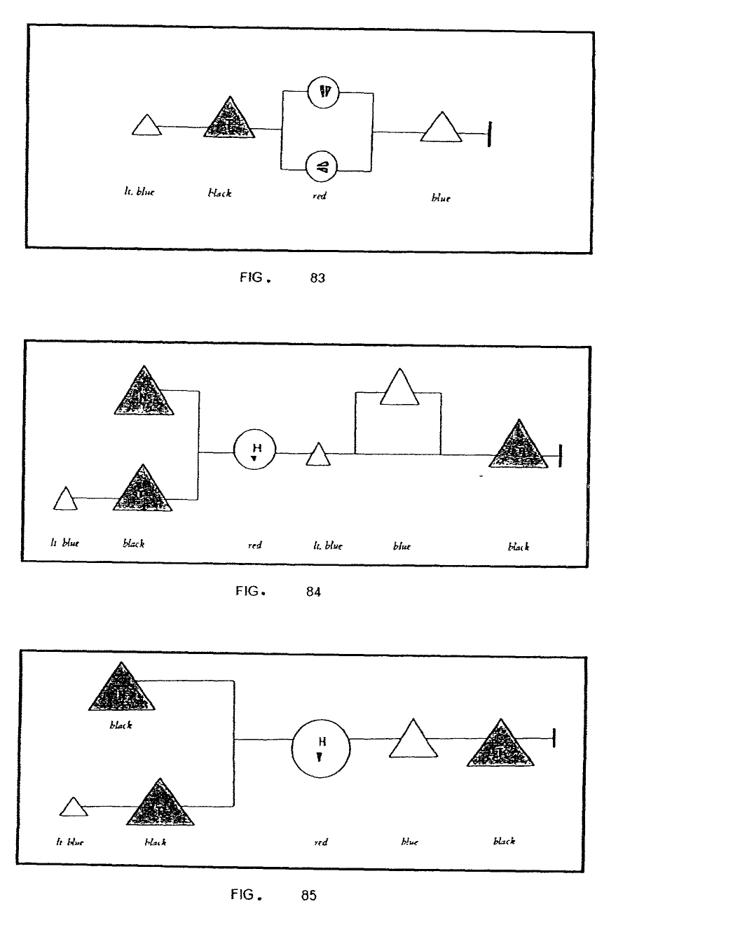

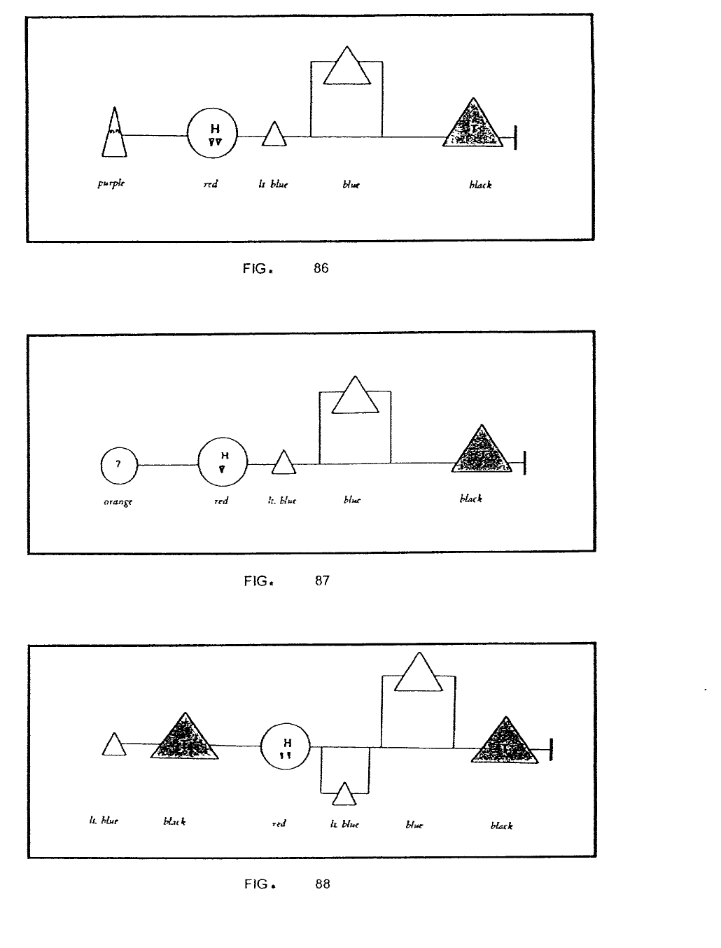

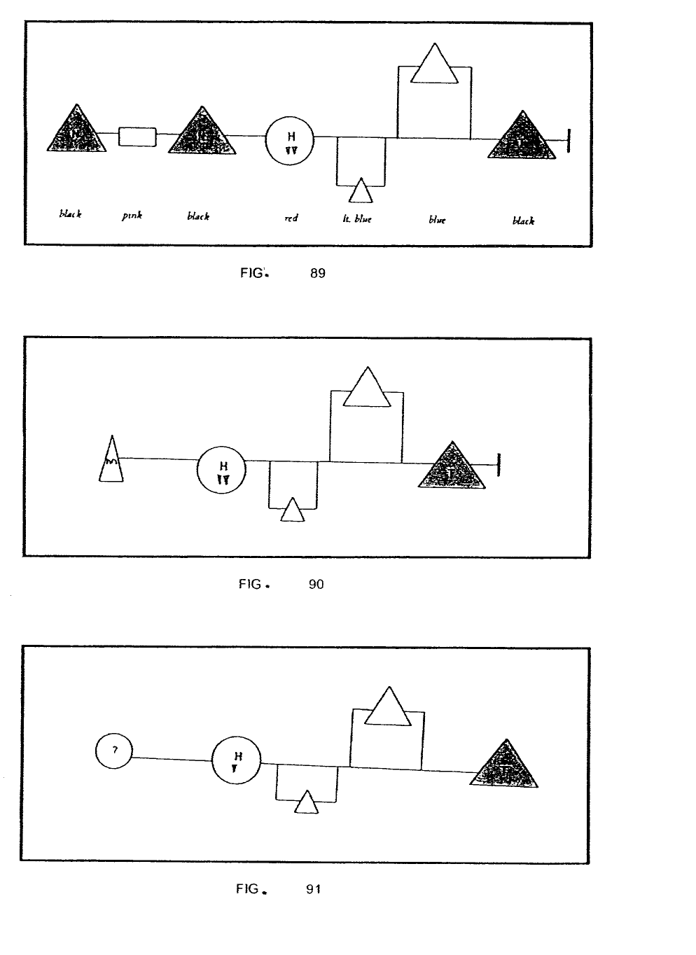

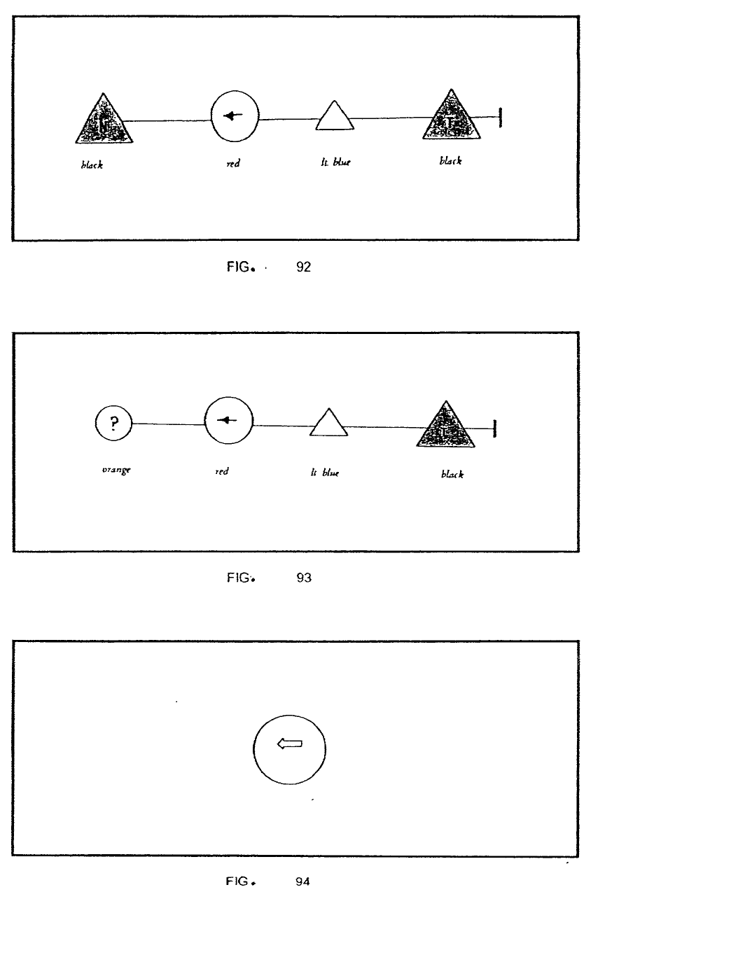

This is a lesson I really enjoyed doing with some 1st graders: Set up the shapes exactly as you did for lesson 11. Do not show the blue adjective shape now. Start with the map illustrated in FIG. 96. Find 4 or 5 boxes, each a different color. One person—ideally another adult—goes out of the room. The child kicks the red box. Write the sentence: Sally kicked the box, or set up the shapes as you did for lesson 11. The adult outside returns to read the sentence. He/she already knows the correct answer (‘red’ in this case), so you'll have to cheat a bit! He/she reads the sentence to the child then picks up any box but not the red box, and asks the child: Was it this box? This box? This box? This box? Lastly pick up the red box. This box? Yes. Send the adult out again, and the child throws the yellow box. Repeat the process above, and the adult still reads the sentence correctly, but still guesses the yellow box only on the last attempt. Repeat this again, with a different action, still guessing wrong.

Now discuss with the students. What is wrong here with this adult? Is she not smart? Why doesn't she know the right box? Can we somehow provide that information? This is then a good time to discuss color, and add the blue adjective triangle, and set up the shapes like the map at the top of this page. Have the student drop the blue box. Annie dropped the blue box. The adult returns and reads the sentence, and picks out the correct box.

Sample Sentences

John dropped the red box. Annie threw the yellow box. Sasha kicked the blue box. Andy squashed the green box.

Reading

Look for this structure in your reading activities.

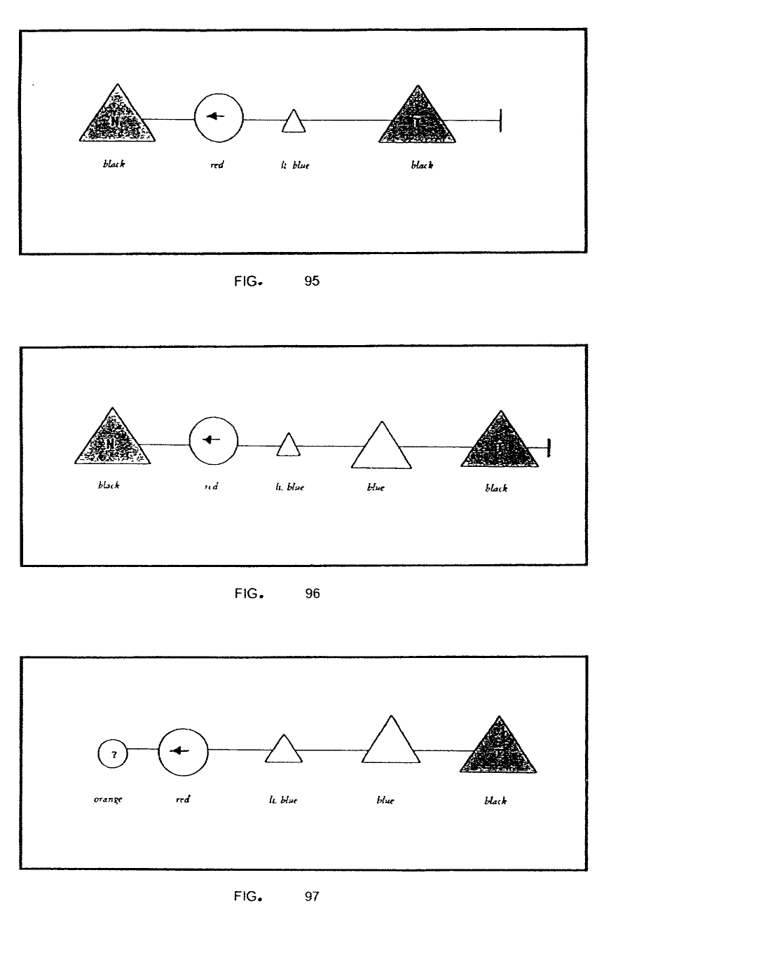

Questions, Referring to FIG. 97

Who threw the yellow box? Who squashed the white cup?

An Excellent Review Activity

Get five books, each one obviously different. (Old, heavy, thin, green, big.) Now hold a T triangle in one hand, and pick up a book. What is it? Book. Now go to the next book. What is it? Book. Go through all the books. It is a little repetitive! What is it? Book. What is it? Book. What is it? Book. Now take a blue triangle and hold it in your hand and pick-up the first book again with the other hand. Go through all the books.

What is it? Big. What is it? Old. What is it? Heavy. What is it? Thin. What is it? Green.

Do the same thing, using pictures of people, each with a different expression. That way you can get man, woman, woman, man, woman with the T triangle, and—using the same pictures again—sad, serious, happy, old, angry with the blue adjective triangle. This activity is an excellent way to reinforce these concepts.

Lesson 13

Purpose of Lesson 13

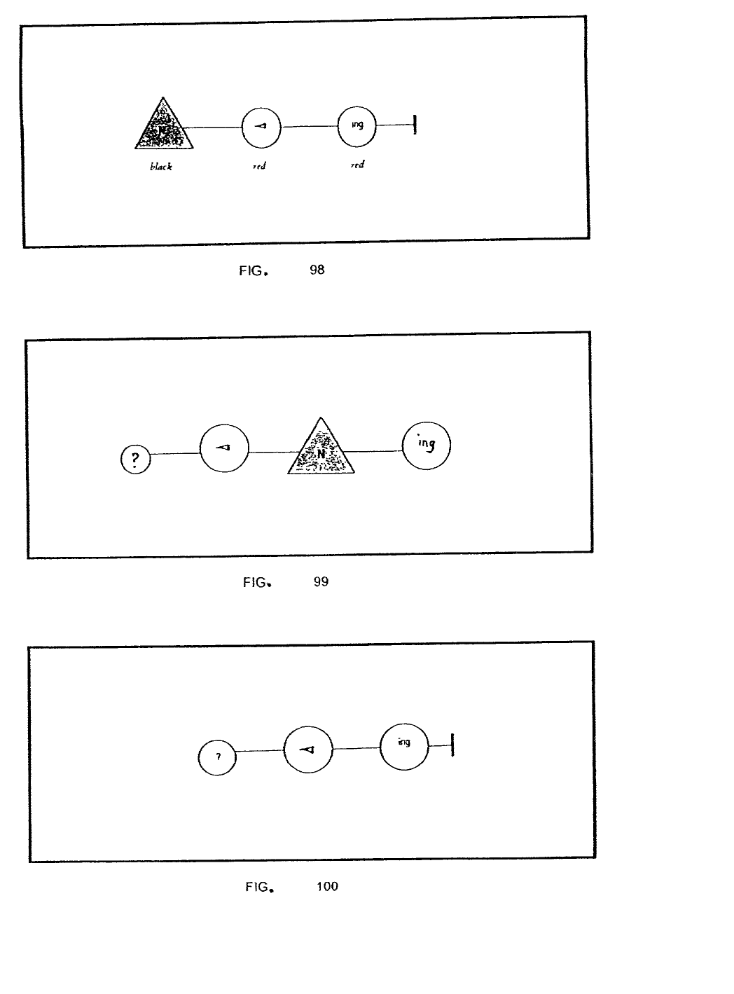

To introduce the past progressive verb structure, and the question form what . . . doing?, illustrated in FIG. 98.

Note. It is important at this stage to show that the BE verb must be with the -ing verb. The -ing verb is like the ticking mechanism of a clock: it needs the hands (the BE verb) to indicate the time something happened. Or else you can liken the -ing verb to a running engine, with the BE verb acting as the gear lever for past, present and future.

Activities

Use either videotape or something like a puppet stage, with a curtain. We need to have children do some actions, but not see those actions either start or stop. For example start with the curtain shut. Open curtains, and see Mary sleeping. Shut curtains after 20 seconds or so. Maybe Mary herself can now come around from behind the curtains, take a bow, and join the group. Discuss Mary's actions with the group. What did you see? Who was sleeping? Did you see Mary wake up? Did you see her stop sleeping? Did you see her yawn and start sleeping? You should then be ready to show the sentence Mary was sleeping. Alternately, you could use videotape. Start with your camera filming away from Mary. Slowly pan around the room, and ‘discover’ Mary sleeping. Film her for 20 seconds, then pan away, and . . . CUT! Have all your students act out things like reading, jumping, eating, drinking, painting.

Reading

With the simple storybooks you are reading, find those sentences that have this verb structure.

Sample Sentences

Mary was sleeping. Rowan was reading. Geoff was painting. Eileen was eating.

Questions, Referring to FIG. 99.

What was Mary doing?

Referring to FIG. 100.

Who was sleeping?

Lesson 14

Purpose of Lesson 14

This lesson looks at the use of was and were with the -ing verb, and introduces the conjunction and. See FIG. 101. Also the options are expanding, and students need to think more about the way each sentence has to be constructed.

Activities

Very similar to lesson 14, except now there are sometimes more than one actors. If making a videotape, film one and two actors randomly.

Sample Sentences

Jane and Sally were sleeping. Mark was reading. Jacob and Alex were hiding.

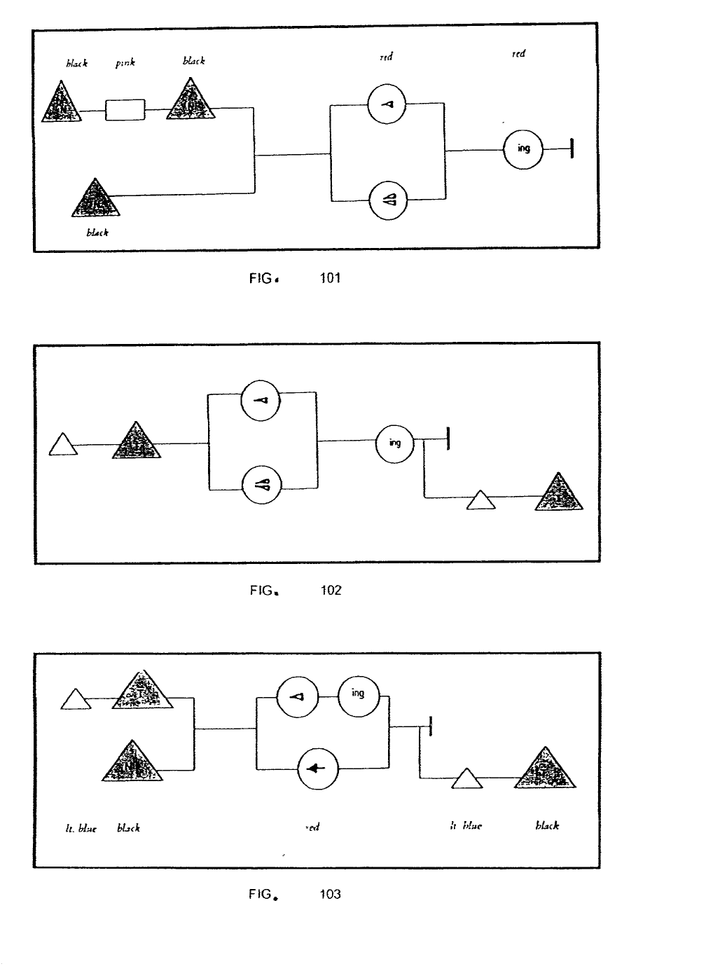

Variant, as Illustrated in FIG. 102

This may be a little harder to introduce now, but if you have video clips or pictures that show continuous action, then this structure can be taught.

Sample Sentences

The dogs were chasing the cat. The girls were pushing the boat. The bird was flying. The baby was crying. The elephants were carrying the people.

Lesson 15

Purpose of Lesson 15

This is a big lesson! The options here for the two verb past tenses, simple past and past progressive, illustrated in FIG. 103, are the most common forms in all literature. When our students are writing stories or journals, we promote these two forms before any others. This lesson encourages the development of the concepts behind the two options, and you can be sure of many interesting discussions, especially around the past progressive, -ing. After all, Rome ruled Europe for 700 years!

Materials

Set up the three dimensional shapes on a table, or the two dimensional shapes on a whiteboard. You can delete the T triangles at both ends for simplicity. This lesson is all about the verbs.

Activities

1. Drama activities are an excellent ways to involve students. To start do just a few actions, and plan ahead, predicting the verbs that you will enact. Past progressive is the one that can cause some confusion. If you use videotaping, then the difference between the two forms can be shown very effectively. (if you are not videotaping, you can still act out this ‘drama’.) Perhaps start with the camera aimed at no one, then slowly pan to the first student, who is asleep. Then onto the next student who winks at the camera. Then onto the next one,

who is reading. Then onto another student who jumps. Pan away, cut or fade. We like to cut a length of videotape, and tape it to the whiteboard. It is a most effective timeline. Those of us with magician's hands try and convince the students that the tape we are using was the one in the camera just filming their actions.

Discuss each action carefully with each student, and link their actions to the correct verb forms in the diagram above. You should end up with the following sentences: Jenny was sleeping, Alan winked, Sally was reading, Leon jumped.

You are ready to make another film, or to perform another play!

In all the discussions you have, refer often to the correct forms, using the shapes. As a game, deliberately set up the shapes incorrectly for an action you are discussing, like Jenny sleeping, Alan was winked. Let the students find the deliberate errors. It is so important for them to understand the correct forms here, as they appear in print and in the alignment of the shapes.

Variant

You can have a pairs of students doing actions like those above, and you could develop sentences like Mary and Sally were sleeping, Jenny and Rosa winked, etc.

For older students, you can use a simple comic strip, like Peanuts, and assign acting roles to each student.

Reading.

These forms of the past tense will appear often in texts, especially stories. In fact, at the early stages, we would recommend choosing storybooks written in the past tense, over those written exclusively in the present. Type sentences with a variety of these two forms, and get the students to find them and write them down, separating the past progressive and the simple in separate columns.

Writing.

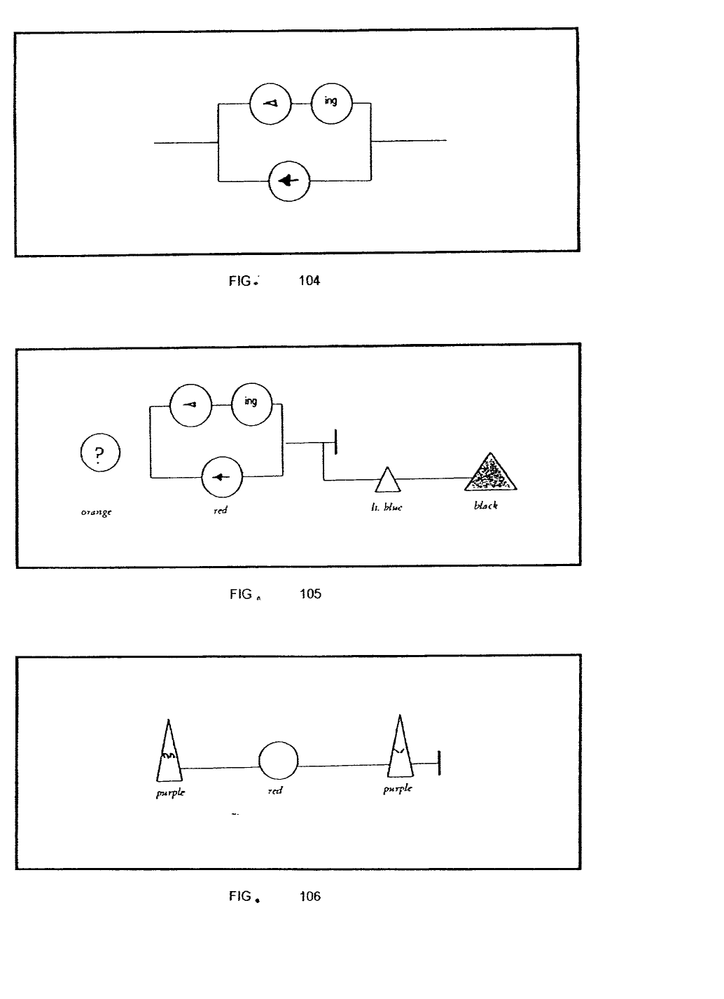

As soon as students start writing simple sentences with actions, model these two forms: make a large display using the ‘map’ illustrated in FIG. 104. Let them think about which one they will use for each sentence.

Questions, Referring to FIG. 105

Who was working? Who dropped the cup?

Lesson 16

Purpose of Lesson 16

To introduce the subject and object pronouns, as illustrated in FIG. 106. This is a simple lesson: after working with this structure you can go back to earlier lessons and substitute the T and the N triangles.

Activities

1. Play with the shapes. The raised ‘eyebrows’ must always be at the start, never the frowning ‘eyebrows’. So you can switch them, and have the students fix them to the right order.

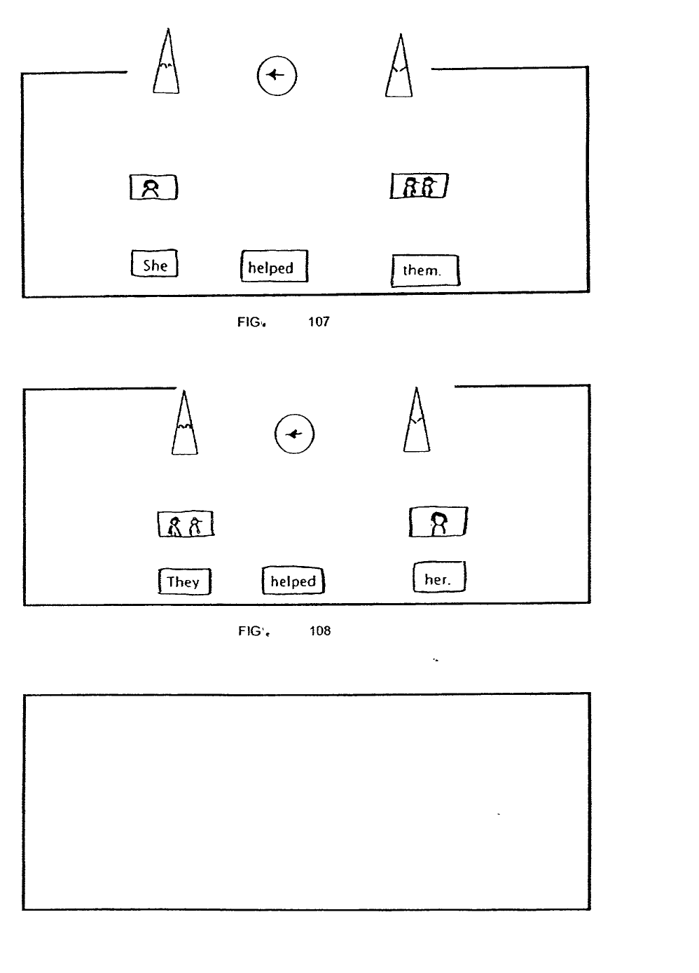

2. You will need the following materials: index cards, pictures of people from magazines or home photographs, and the three-dimensional or two-dimensional shapes. Using the magazine pictures, cut out pictures of a woman, a man, a boy, a girl, some men, some boys, some people, some women, some girls, etc. We have several in each ‘category’. Paste the pictures to index cards. Write on some other index cards the subject pronouns /, she, he, we, you, they, and object pronouns, me, her, him, us, you, them. Now establish one simple action verb, like helped, write that word on an index card. Place the shapes above the cards. Take two of your picture cards and set them up, as illustrated in FIG. 107. Now switch the two picture cards. ‘They’ want to return the favor, illustrated in FIG. 108. The point here is that the pictures switch places, but the symbols do not. In the first sentence the girl is identified as ‘she’, in the second she is ‘h e C Likewise, ‘them’ changes to ‘they’. Repeat this game with your other pictures. Add a picture of you—the parent or teacher—and the child, so you can work with T, ‘me’, ‘you . . . and ‘you’!

This lesson helps develop the concept of the subject and object’ ‘pronouns, but your students will also need to learn the correct spelling of these various forms. We have a banner showing the pronoun symbols, which students can refer to, illustrated by FIG. 6

Sample Sentences

She helped them. I told you. He asked her. They helped her. You told me. She asked him.

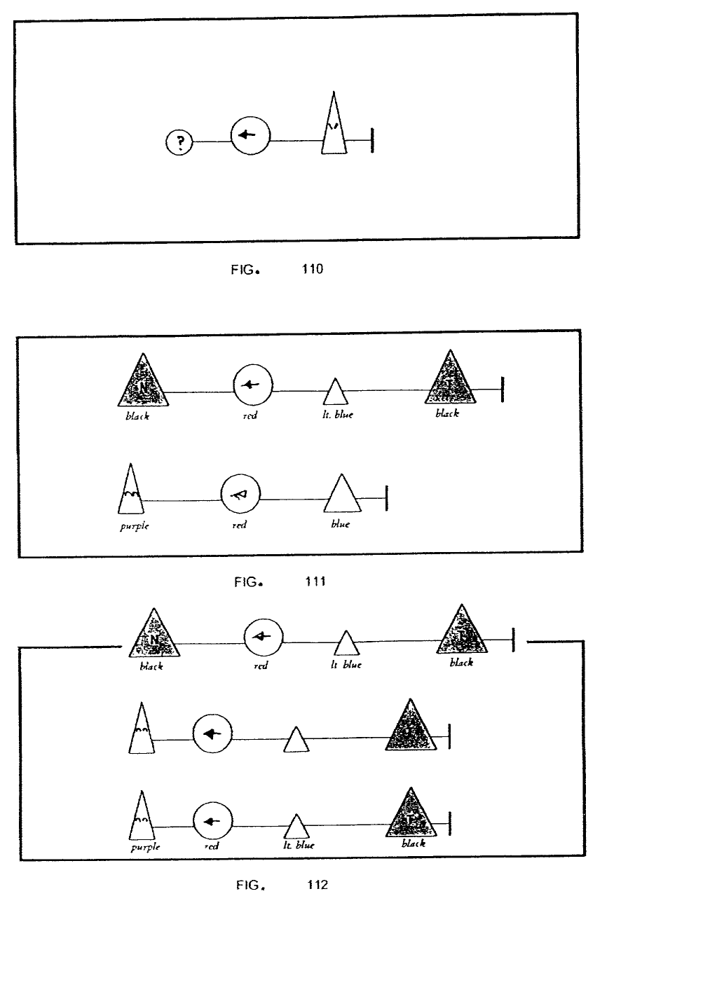

Question, Referring to FIG. 110

Who helped him? Who followed them?

Lesson 17

Purpose of Lesson 17

To apply subject pronouns, and to show how they might be used in a second sentence about one simple topic, illustrated in FIG. 111. Note. The red shape in the first sentence can be used for the past progressive or simple past: we have put down one circle for simplicity.

Activities

Very similar to lesson 15. Ask students to do simple actions: you can videotape them. For example you could have Anna eating an apple. Now set up the shapes in the 2 sentence lines above. The first sentence should be easy: Anna was eating the apple.

Now discuss the second sentence. Why was she eating the apple? Was she tired? Was she thirsty? Was she hungry? The discussion should lead to: She was hungry.

Discuss the reason for the pronoun. If the second sentence involves the subject—or object—of the first sentence, it is usually better to use a pronoun than the noun a second time. See the sample sentences below to see how this applies.

Sample Sentences

Eric was drinking the water. He was thirsty. Sally was washing the car. It was dirty. Alan caught the fish. It was tiny. Sheena left the room. She was late.

Lesson 18

Purpose of Lesson 18

Reinforce the use of pronouns, illustrated in FIG. 112.

Activities

The same kind of things as you did in lesson 11, except that now you will ask one student to do 2 or 3 things.

See the sample sentences to get some ideas for the actions.

Sample Sentences

Kristen opened the box. She closed the book. She moved the lamp. Bob entered the room. He caught the ball. He tore the paper. Hastings rolled the ball. He bit the apple. He opened the window.

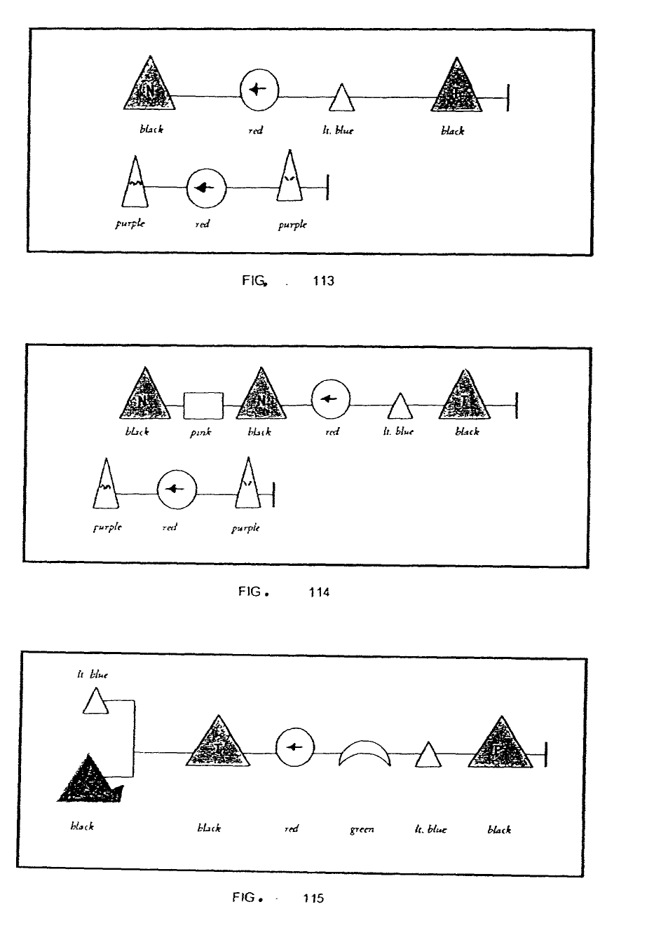

Variant I, Referring to FIG. 113

Sample Sentence

Terri opened the box. She threw it. Emma carried the eggs. She dropped them.

Variant 2, Referring to FIG. 114

Sample Sentences

Shareen and Amy pushed the table. They turned it. Max and Archie took the pencils. They sharpened them. Holly and Sheri bounced the balls. They threw them.

Reading Activity

From these variants you can see that there are many ways of applying subject and object pronouns. It would be a good idea to find these pronouns in their reading books. Photocopy a paragraph or two with a few pronouns.

Ask the student to underline the pronouns: use a purple pencil. If there is room, they can draw purple frowning or raised eyebrows over each one. Ask the student to tell you what each pronoun is referring to. For example:

Connie went to the store. It was still open. She needed some new paint. She looked at a few colors. She bought two cans of paint. They were expensive! The guy in the store opened the door for her. He was the owner. Connie thanked him. Connie carried the cans of pain to the car. She put them in the trunk.

Lesson 19

Purpose of Lesson 19

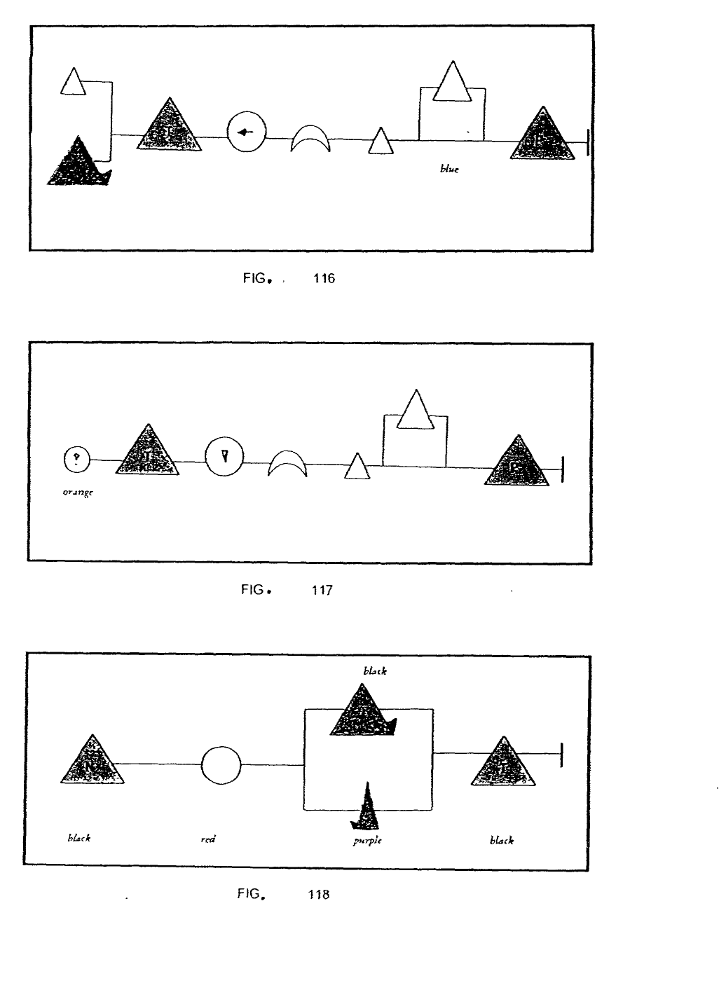

Introduce the possessive noun, illustrated in FIG. 115.

Activities

Set up objects from around the room. You will need to borrow some of your students' things! Put a few hats on the table. Put Jo's hat on the cup. You could write the hat is on the cup. This is not wrong. But we want something better. Is it Emma's hat? Jerry's? Yes, Jo's. We can show that with this shape here. The black triangle is Jo, and this ‘thumb ’ is like the American Sign Language sign for Jo—hers. We now have this sentence:

Jo's hat is on the cup.

Sample Sentences

Mary's book is on the floor. Jackson ” bag is on the shelf Mia's car is under the chair.

Variant

Add an adjective. Get a pencil from each student. Put each pencil on a different colored book. Write the sentence the pencil is on the book.

It is not wrong, but I am looking at 5 pencils, and 5 books. Which pencil, and which book!? Let's look at this map, illustrated in FIG. 116, and make a better, clearer sentence:

You could get more sentences like these:

Kerri's pencil is on the red book. Todd's pencil is on the yellow book. Kristen's pencil is on the green book. Mary's pencil is on the blue book.

Questions, Referring to FIG. 117

Whose pencil is on the yellow book?

Practice asking each other questions with whose.

Whose hair is brown? Whose bike is red? Whose book is on the shelf?

Reading

Once again, look for these structures in your reading books.

Lesson 20

Purpose of Lesson 20

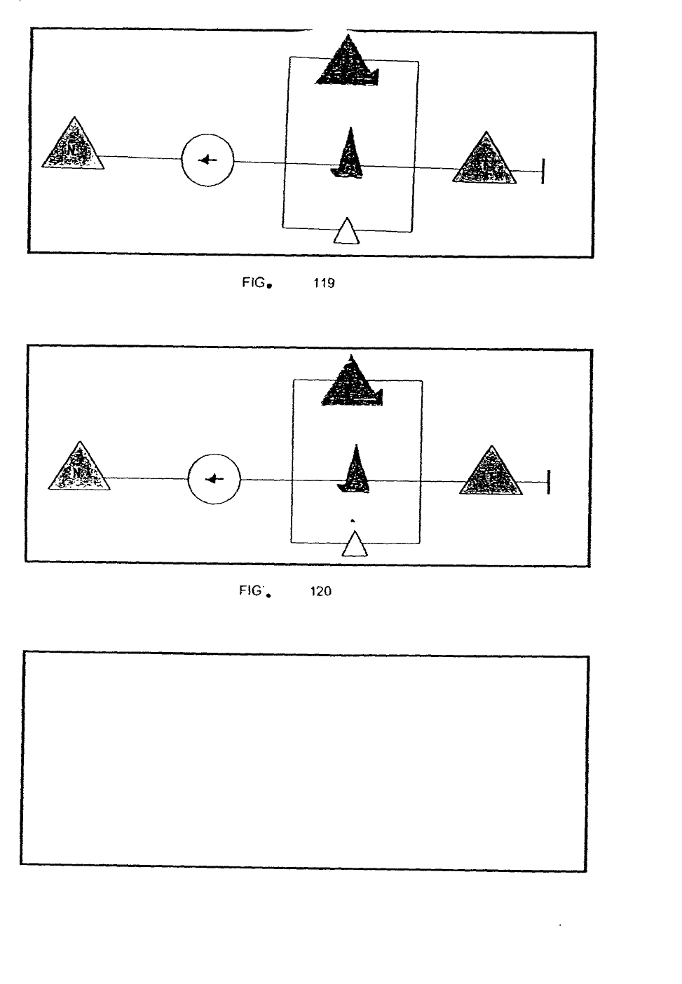

To show the different use of possessive nouns and pronouns, illustrated in FIG. 118.

Activities

Once again, these concepts can be shown very clearly with some simple drama activities. You will need either two students, or to act yourself. Use the shapes and set up the map above.

Act I

Both students are wearing a hat. Jack lifts Jolene's hat. Jolene then lifts Jack's hat.

Use the map above to make simple sentences. Lead the discussion with questions. What did Jack do? Which hat? jolene's? Then what did Jolene do?

Jack lifted jolene's hat. Jolene lifted jack's hat.

Act 2

Jolene drops hers. Jack drops his own hat.

Again the same discussion. What did Jolene do? Whose hat?

Write this sentence: Jolene dropped Jolene's hat. Point to the second Jolene in the sentence. We do not need the same name two times here. We can use the purple shape, and the word her because we know who it is. Jolene dropped her hat. Jack dropped his hat.

From the sample sentences you can see the kinds of actions you can do.

Sample Sentences

Ellen sharpened her pencil. Mark closed Sue's book. Fred wiped his shoes. Ginger tapped Annie's shoulder.

Variant, Referring to FIG. 119

Add the light blue triangle. In your discussions you can determine which of the three options above would be the best to use. Sometimes there is no need to show ownership, and articles like a, or, the are fine:

Sample Sentences

Geoff closed the window. Sarah folded her paper. Ben copied Therese's homework.

Reading

Look for these structures in your reading, especially after you have done this lesson. The reading activity would be an excellent compliment to the lesson. Find the possessives in a page from your reading book, and work with the student in deciding what each possessive stands for. From the sample sentences you can see the kinds of actions you can do.

Sample Sentences

Ellen sharpened her pencil. Mark closed Sue's hook. Fred wiped his shoes. Ginger tapped Annie's shoulder.

Variant, Referring to FIG. 120

Add the light blue triangle. In your discussions you can determine which of the three options above would be the best to use. Sometimes there is no need to show ownership, and articles like a or the are fine:

Sample Sentences

Geoff closed the window. Sarah folded her paper. Ben copied Therese's homework.

Look for these structures in your reading, especially after you have done this lesson. The reading activity would be an excellent compliment to the lesson. Find the possessives in a page from your reading book, and work with the student in deciding what each possessive stands for.

### EXAMPLE 6

### Improvement Over Time Utilizing the Preferred Embodiment of the Present Invention

Student M

May 23, 2000

Jimmy's walking see penicl put to your pant. Jimmyls was walking see chair put to tlabe. then Jimmy's put cup to chair. Jimmy was left.

School Year 1999-2000

The gril wanted with dog play outside ball throw. Mom wacth chirdren for play. Where ok groud yard back.

Sep. 22, 2000

Jimmy entered drank. He put on shelves. Jimmy picked expo draw house. Jimmy picked ball threw

trashcan. He picked stool. He open window threw stool. He close window He left.

Dec. 13, 2000

Clayton III entered the classroom. He brought the red sciccors. He cut the white paper. He gave the its to Cruz. He walked and pick up the little blue stool. He put on the its on the blue rug. He took the little blue maker. He drew on the wall. He picked Up the little blue stool. He brought its and he left.

### EXAMPLE 7

### Improvement Over Time Utilizing the Preferred Embodiment of the Present Invention

Student CT

Aug. 3, 1999

King loved clothes. King had lot shoe, silks, and other clothes. King won't give poor people and solders. King always brought many shoes, silks, and other clothes.

Many people wanted other King for meet. Many people wanted war or other. Many people talked about kind always brought clothes. Some people saw King's, love clothes. Some people little talked about King's clothes. Other people telled to other King about two people ture best made clothe's. Other King said, “Fine.”

Two men talked to King about need thing silk, gold, smooth., and other clothes. King said, “That is lot money.” But king can brought thing for clothes.

Two men got things clothes from king's brought. They put bag for king's brought.

Nov. 15, 1999

I Rob entered the classroom with his tan straw hat. He was looking the key. He searched under the table. Rob noticed Jimmy was reading the real book. Then he put the straw hat on the wooden chair. He walked away from the chair. Jimmy sat the wooden chair. He did squashed the straw hat on the wooden chair. Rob tapped he. He stood up. Rob grabbed the straw hat from the wooden chair. He said., “Sorry.” Rod put the straw hat on the table near the window. He took the new brown boot. Then he spilled the water out of the boot. Jimmy shocked he spilled. He put back the book on the small wooden desk. He said, “Where key is.” Jimmy said, “Don't know where is.” He said, “Ok.” He left.

The invention has been described in detail with particular reference to certain preferred embodiments thereof, but it will be understood that variations and modifications can be effected within the spirit and scope of the invention.

What is claimed is:

1. A manipulative visual language tool for teaching grammar and syntax of a language comprising at least one colored shape further comprising a graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech.

2. The manipulative visual language tool of claim 1 wherein said at least one colored shape comprises at least two dimensions.

3. The manipulative visual language tool of claim 1 wherein said at least one colored shape comprises at least three dimensions.

4. The manipulative visual language tool of claim 1 wherein said at least one colored shape comprises a geometric shape.

5. The manipulative visual language tool of claim 1 wherein said language comprises English.

6. The manipulative visual language tool of claim 1 wherein said tool comprises a tool for the deaf.

7. The manipulative visual language tool of claim 1 wherein said at least one colored shape comprises a plurality of colored shapes further comprising a set.

8. The manipulative visual language tool of claim 1 wherein said colored shape represents a single grammatical parts of speech selected from the group consisting of nouns, pronouns, verbs, adverbs, adjectives, conjunctions, prepositions, gerunds, negatives or determiners.

9. The manipulative visual learning tool of claim 8 wherein said nouns comprise the varieties of names, places, and things.

10. The manipulative visual learning tool of claim 8 wherein pronouns comprise the varieties of possessive, subject, and object pronouns.

11. The manipulative visual learning tool of claim 8 wherein said verbs comprise the varieties of simple present, simple past, simple future, continuous past, continuous present, continuous future, perfect past, perfect present, perfect future, perfect progressive past, perfect progressive present, and perfect progressive future tense.

12. The manipulative visual learning tool of claim 8 wherein adverbs comprise the varieties of manner, place, time, degree, interrogatory, and frequency.

13. The manipulative visual learning tool of claim 8 wherein said adjectives comprise the varieties of quantity, opinion, size, shape, age, color, origin, materials, and qualifier.

14. The manipulative visual learning tool of claim 8 wherein said conjunctions comprise and, but, and because.

15. The manipulative visual learning tool of claim 8 wherein said negatives comprise not

16. The manipulative visual learning tool of claim 8 wherein said prepositions comprise the varieties of with verbs of transport, in, and on.

17. The manipulative visual learning tool of claim 8 wherein said determiners comprise articles, possessives and adjectives of amount.

18. A method of teaching the grammar and syntax of a language comprising:
providing a manipulative visual language tool for teaching grammar and syntax of a language comprising at least one colored shape further comprising at least one graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech; and
Exposing at least one individual to said manipulative visual language tool.

19. A method of teaching the grammar and syntax of a language comprising:
providing a manipulative visual language tool for teaching grammar and syntax of a language comprising at least one colored shape further comprising at least one graphical indicator, wherein said language comprises at least one grammatical part of speech, wherein said at least one grammatical part of speech comprises at least one variety of said grammatical part of speech, wherein said at least one colored shape comprises a single grammatical part of said at least one grammatical part of speech, and wherein said graphical indicator comprises a single variety of said at least one variety of said at least one grammatical part of speech;
Exposing at least one individual to one of said at least one colored shape;
Exposing said individual to one of said at least one graphical indicator of said at least one colored shape;
Repeating the exposure of said individual to said at least one graphical indicator of said at least one colored shape until all of said at least one graphical indicator of said at least one colored shape have been exposed;
Exposing said individual to a second of said at least one colored shape;
Exposing said individual to one of said at least one graphical indicator of said second of at least one colored shape;
Repeating the exposure of said individual to said at least one graphical indicator of said second of at least one colored shape until all of said at least one graphical indicator of said second of at least one colored shape have been exposed; and
Repeating the above steps said individual has been exposed to all of said at least one colored shapes.
